(19) United States
(12) Patent Application Publication
(10) Pub. No.: US 2024/0303802 A1
(43) Pub. Date: Sep. 12, 2024

(54) ANOMALY DISPLAY DEVICE, ANOMALY DISPLAY PROGRAM, ANOMALY DISPLAY SYSTEM, AND ANOMALY DISPLAY METHOD

(71) Applicant: LeapMind Inc., Tokyo (JP)

(72) Inventors: Atsushi HANAMOTO, Tokyo (JP); Ryuji TANAKA, Tokyo (JP)

(21) Appl. No.: 18/573,866

(22) PCT Filed: Jun. 8, 2022
(86) PCT No.: PCT/JP2022/023096

§ 371 Date: Dec. 22, 2023

(30) Foreign Application Priority Data
Jun. 29, 2021 (JP) 2021-108017

(51) Int. Cl. G06T 7/00; G06T 7/11; G06T 11/00

(52) U.S. Cl. CPC G06T 7/001; G06T 7/11; G06T 11/00; G06T 2207/20021; G06T 2207/20081; G06T 2207/30108

(57) ABSTRACT

An anomaly display device provided with a starting information acquisition unit that acquires starting information including information for starting anomaly detection for detecting an anomaly in an image included in an input picture; an input picture acquisition unit that acquires the input picture; an anomaly detection unit that executes the anomaly detection, based on the acquired starting information, by comparing the acquired input picture with information based on a prestored normal picture; and a display unit that displays, in overlay on the input picture, information based on information detected by the anomaly detection unit.

### CROSS REFERENCE TO RELATED APPLICATIONS

This application is the U.S. National Stage entry of International Application No. PCT/JP2022/023096, filed on Jun. 8, 2022, which claims priority to Japanese Patent Application No. 2021-108017, filed on Jun. 29, 2021, the disclosures both of which are incorporated herein by reference in their entireties for all purposes.

### TECHNICAL FIELD

The present invention relates to an anomaly display device, an anomaly display program, an anomaly display system, and an anomaly display method.

### BACKGROUND ART

Conventionally, at manufacturing sites, improvements in production efficiency by the automation of production lines are sought. In particular, anomaly detection technology using picture processing is applied to processes for sorting out defective products by inspecting the outer appearances of produced products. As an example of such technology, anomaly detection technology using machine learning is known (see, for example, Patent Document 1).

### CITATION LIST

### Patent Documents

[Patent Document 1] JP 2021-064356 A

### SUMMARY OF INVENTION

### Technical Problem

However, with such conventional art, captured pictures of products at a manufacturing site are transferred to a server installed at a location different from the manufacturing site via a communication network such as the internet.

Depending on the products being manufactured at the manufacturing site, there are cases in which the inspected pictures themselves are confidential information, and transferring pictures to the outside is undesirable. Additionally, in the case in which inspected pictures are transferred to the outside, there was a problem in that, depending on the network connection, the transfer time could not be ignored, and efficient inspections could not be performed.

Therefore, an objective of the present invention is to provide an anomaly detection program, an anomaly detection device, an anomaly detections system, and an anomaly detection method enabling anomaly detection to be easily performed.

### Solution to Problem

An anomaly display device according to an embodiment of the present invention is provided with a starting information acquisition unit that acquires starting information including information for starting anomaly detection for detecting an anomaly in an image included in an input picture; an input picture acquisition unit that acquires the input picture; an anomaly detection unit that executes the anomaly detection, based on the acquired starting information, by comparing the acquired input picture with information based on a prestored normal picture; and a display unit that displays, in overlay on the input picture, information based on information detected by the anomaly detection unit.

Additionally, in an anomaly display device according to one embodiment of the present invention, the starting information includes a path indicating a location at which the input picture is stored; and the input picture acquisition unit acquires the input picture stored at the location indicated by the path.

Additionally, in an anomaly display device according to one embodiment of the present invention, the starting information includes an image capture starting signal for making an image capture unit capture the image; and the input picture acquisition unit acquires the input picture obtained by the image being captured by the image capture unit.

Additionally, an anomaly display device according to one embodiment of the present invention further comprises a picture correction unit that corrects the input picture; wherein the anomaly detection unit executes the anomaly detection by comparing the input picture corrected by the picture correction unit with a prestored normal picture.

Additionally, an anomaly display device according to one embodiment of the present invention further comprises a correction selection information acquisition unit that acquires correction selection information for selecting a type of correction process to be executed by the picture correction unit.

Additionally, in an anomaly display device according to one embodiment of the present invention, the anomaly detection unit is pre-trained by a prescribed normal picture.

Additionally, in an anomaly display device according to one embodiment of the present invention, the starting information includes training execution selection information indicating whether the anomaly detection unit is to perform training based on a prescribed normal picture or is to execute the anomaly detection; and the anomaly detection unit executes either the training or the anomaly detection based on the training execution selection information included in the starting information.

Additionally, in an anomaly display device according to one embodiment of the present invention, the information based on a prestored normal picture includes information on a mean value vector and variance of the normal picture; the anomaly detection unit performs anomaly detection corresponding to multiple split regions, which are regions into which the input picture has been split; and the display unit displays, in overlay on the input picture, the information detected by the anomaly detection unit, so as to be associated with the multiple split regions.

Additionally, an anomaly display program according to one embodiment of the present invention makes a computer execute: a starting information acquisition unit step of acquiring starting information including information for starting anomaly detection for detecting an anomaly in an image included in an input picture; an input picture acquisition step of acquiring the input picture; an anomaly detection step of executing the anomaly detection, based on the acquired starting information, by comparing the acquired input picture with a prestored normal picture; and a display step of displaying, in overlay on the input picture, information based on information detected by the anomaly detection step.

Additionally, an anomaly display system according to one embodiment of the present invention is provided with an image capture unit that captures the image; and the anomaly display device that executes the anomaly detection on the input picture captured by the image capture unit, and that displays information obtained as a result of the execution.

Additionally, an anomaly display method according to one embodiment of the present invention includes a starting information acquisition step of acquiring starting information including information for starting anomaly detection for detecting an anomaly in an image included in an input picture; an input picture acquisition step of acquiring the input picture; an anomaly detection step of executing the anomaly detection, based on the acquired starting information, by comparing the acquired input picture with a prestored normal picture; and a display step of displaying, in overlay on the input picture, information based on information detected by the anomaly detection step.

### Advantageous Effects of Invention

According to the present invention, anomalies can be easily detected from picture information.

### BRIEF DESCRIPTION OF DRAWINGS

FIG. 1 is a functional configuration diagram illustrating an example of the functional configuration of an anomaly detection system according to an embodiment.

FIG. 2 is a diagram illustrating an example of a normal input picture and an anomalous input picture according to an embodiment.

FIG. 3 is a diagram for explaining the concept of an anomaly detection system according to an embodiment.

FIG. 4 is a diagram for explaining layers provided in an inference unit according to an embodiment.

FIG. 5 is a functional configuration diagram illustrating an example of the functional configuration of an anomaly detection unit according to an embodiment.

FIG. 6 is a diagram for explaining splitting according to an embodiment.

FIG. 7 is a functional configuration diagram illustrating an example of the functional configuration of an operation unit according to an embodiment.

FIG. 8 is a functional configuration diagram illustrating a modified example of the functional configuration of an anomaly detection unit according to an embodiment.

FIG. 9 is a diagram illustrating an example of an output result from an output unit according to an embodiment.

FIG. 10 is a flow chart for explaining a series of operations in a “detection” process in an anomaly detection system according to an embodiment.

FIG. 11 is a flow chart for explaining a series of operations in a “training” process in an anomaly detection system according to an embodiment.

FIG. 12 is a diagram for explaining a problem in a product inspection system according to the conventional art.

FIG. 13 is a diagram for explaining a training process in an anomaly display device according to an embodiment.

FIG. 14 is a diagram for explaining an inspection process in an anomaly display device according to an embodiment.

FIG. 15 is a functional configuration diagram illustrating an example of the functional configuration of an anomaly display device according to an embodiment.

FIG. 16 is a diagram illustrating an example of a screen configuration of a display screen of an anomaly display device according to an embodiment.

FIG. 17 is a diagram illustrating an example of picture correction of an input picture according to an embodiment.

FIG. 18 is a diagram illustrating an example of a normal picture according to an embodiment.

FIG. 19 is a diagram illustrating an example of an inspection result of an anomaly display device according to an embodiment.

FIG. 20 is a flow chart for explaining a series of operations in a training process in an anomaly detection system according to an embodiment.

FIG. 21 is a flow chart for explaining a series of operations in an inspection process in an anomaly detection system according to an embodiment.

FIG. 22 is a diagram for explaining a first modified example of an anomaly display device according to an embodiment.

FIG. 23 is a diagram for explaining a second modified example of an anomaly display device according to an embodiment.

### DESCRIPTION OF EMBODIMENTS

Hereinafter, embodiments of the present invention will be explained with reference to the drawings. The embodiments explained below are merely exemplary, and the embodiments to which the present invention can be applied are not limited to the embodiments below.

### Problems of Conventional Art

First, the problems of the conventional art will be explained.

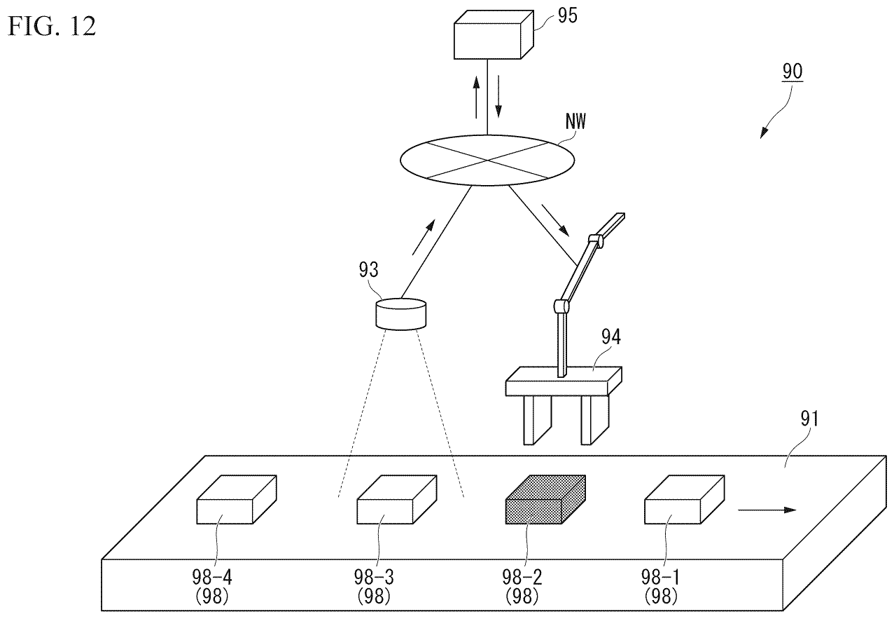

FIG. 12 is a diagram for explaining the problems in a product inspection system according to the conventional art. The product inspection system 90 according to the conventional art will be explained with reference to said diagram. The product inspection system 90 according to the conventional art is provided in a product manufacturing plant, detects whether or not there are defects in the outer appearances of manufactured products, and removes products in which defects have been detected from the manufacturing line.

The product inspection system 90 according to the conventional art is provided with a product conveyance belt 91, an image capture unit 93, a gripping device 94, and a picture processing server 95.

The product conveyance belt 91 conveys manufactured products 98. The product conveyance belt 91 may be a belt conveyor or the like. The products 98 are placed on the product conveyance belt 91 and conveyed inside the manufacturing plant. The products 98 may be finished products manufactured in the manufacturing plant or may be components used during manufacture. Additionally, the products 98 are not limited to industrial products, and may be materials, food products, pharmaceutical products, etc. The image capture unit 93 is provided at a position from which pictures of the products 98 being conveyed on the product conveyance belt 91 can be captured, and captures pictures of the outer appearances of the products 98. The captured pictures are transferred to a picture processing server 95 via a prescribed communication network NW.

The picture processing server 95 is provided at a site different from the manufacturing plant in which the product inspection system 90 according to the conventional art is provided. The picture processing server 95 processes the transferred pictures and determines whether the pictures are normal pictures or anomalous pictures. The picture processing server 95 has an anomaly detection algorithm based, for example, on machine learning. The anomaly detection algorithm may be learned in advance. The picture processing server 95 transfers the results of the determination whether the transferred pictures are normal pictures or anomalous pictures, via a prescribed communication network NW, to a prescribed machine, for example, a gripping device 94, provided in a manufacturing plant according to the conventional art.

The gripping device 94 grips products 98 for which anomalous pictures have been detected based on the results determined by the picture processing server 95, and removes them from the manufacturing line. The gripping device 94 may remove the products 98 for which anomalous pictures have been detected from the manufacturing line by another method different from gripping. The other method may, for example, be to change the path of the product conveyance belt 91, which is a belt conveyor, etc.

In the example illustrated in FIG. 12, a product 98-1, a product 98-2, a product 98-3, and a product 98-4 are conveyed on the product conveyance belt 91, and the product 98-2 is determined to have an anomalous outer appearance. For this reason, the gripping device 94 grips the product 98-2 and removes it from the manufacturing line.

In this case, according to the product inspection system 90 of the conventional art, a captured picture must once be transferred outside the manufacturing plant via the communication network NW. Therefore, depending on the connection speed of the network connection connecting the communication network NW with the manufacturing plant, there are cases in which the transfer takes time. There are cases in which the product conveyance belt 91 transfers the products 98 at a high speed, and in such cases, in particular, anomalous appearances must be detected quickly.

Therefore, there was a demand for an anomaly detection system capable of quickly determining whether or not there is an anomaly in the outer appearance.

Additionally, according to the product inspection system 90 of the conventional art, captured pictures must be transferred to the outside of the manufacturing plant. Therefore, there is a possibility that confidential information could be acquired by a third party on the link during transfer or in the picture processing server 95. There are cases in which the products 98 are products that have not yet been brought to market, and in such cases in particular, there is a demand for keeping the confidential information from being leaked. Additionally, there are cases in which the manufacturing steps or machining steps themselves are confidential information.

Therefore, there was a demand for an anomaly detection system capable of assessing anomalous pictures without transferring the pictures outside a manufacturing plant.

The anomaly detection system 1 according to the present embodiment is for solving the problem mentioned above.

### [Summary of Anomaly Detection System]

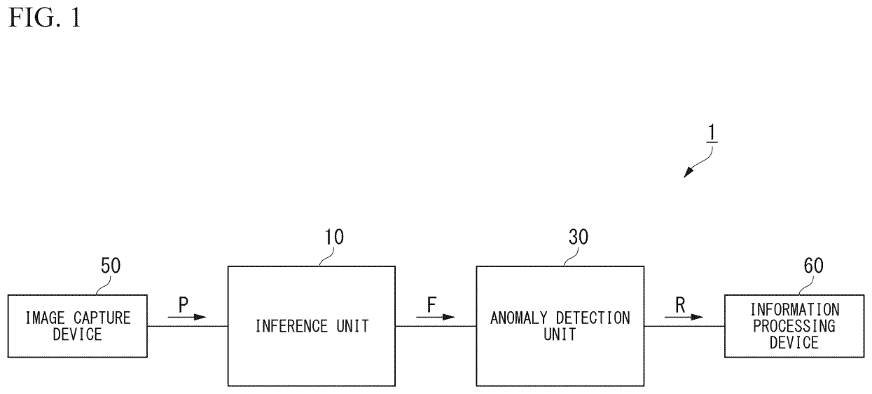

FIG. 1 is a functional configuration diagram illustrating an example of the functional configuration of the anomaly detection system according to an embodiment. The anomaly detection system 1 according to the present embodiment will be explained with reference to said diagram. In the description below, an example of the case in which the anomaly detection system 1 according to the present embodiment is provided in a manufacturing plant and detects anomalies in manufactured products or components will be explained. However, the anomaly detection system 1 is not limited to the example of the case of being provided in a manufacturing plant. For example, the anomaly detection system 1 may be installed in a food processing plant or the like, and may be used for pre-shipment inspection by detecting anomalies in food products, materials, etc.

Additionally, the anomaly detection system 1 may be provided in an edge device driven by a battery or the like, and as one example, may be provided inside a portable electronic device such as a digital camera or a smartphone.

Additionally, the anomaly detection system 1 according to the present embodiment is not limited to the example of the case in which anomalies are detected in pictures captured inside a plant. The anomaly detection system 1 may, for example, use pre-captured pictures as the input pictures.

The anomaly detection system 1 is provided with an image capture device 50, an inference unit (inference device) 10, an anomaly detection unit (anomaly detection device) 30, and an information processing device 60.

The respective blocks included in the anomaly detection system 1 are integrally controlled by a host processor, which is not illustrated. The host processor controls the blocks by executing a program that is pre-stored in a memory, which is not illustrated. The host processor may be configured to realize some of the functions of the anomaly detection system 1 by executing the program stored in the memory.

The image capture device 50 captures pictures of objects. By capturing pictures of the objects, the image capture device 50 acquires information regarding the outer appearances of the products. The image capture device 50 transfers the captured pictures, as input pictures P, to the inference unit 10. The image capture device 50 is, for example, a stationary camera installed on a manufacturing line.

In the case in which pictures pre-captured by the anomaly detection system 1 are used as the input pictures P, the anomaly detection system 1 may be provided with a storage device, not illustrated, instead of the image capture device 50.

The inference unit 10 acquires the input pictures P from the image capture device 50 and extracts one or more feature maps F from the input pictures P. Specifically, the inference unit 10 includes a neural network trained to predict classes and likelihoods for objects included in the input picture P. From the intermediate layers in the inference unit 10, multiple feature maps F are extracted as the results of computations based on multiple features.

Depending on the devices installed in the anomaly detection system 1, there is a risk that the computational processing load relating to the neural network will be excessive. In such cases, it is desirable to configure the neural network so as to include quantization operations during the computational processes associated with the neural network. As one example, the neural network may be provided with a quantization operation unit that quantizes activations for performing convolution operations included in the computational processes relating to the neural network to 8 bits or less (for example, 2 bits or 4 bits), and that quantizes weights to 4 bits or less (for example, 1 bit or 2 bits).

In this case, the input pictures P input to the inference unit 10 may be of any size.

The size of the input pictures P input to the inference unit 10 should preferably be the same as the size of the pictures used when training the inference unit 10. In order to provide the pictures input to the inference unit 10 with the same conditions as those at the time of training, the sizes, conditions, etc. of the input pictures P may be corrected by a correction unit that is not illustrated, and thereafter, the corrected input pictures P may be input to the inference unit 10.

Specifically, as the inference unit 10, a VGG16 may be used. A VGG16 is a convolutional neural network (CNN) consisting of a total of 16 layers. As a pre-trained model, an existing pre-trained model may be used, or a model obtained by additionally training an existing pre-trained model may be used. In the case in which additional training is to be performed, it is preferable to use, as the input pictures P, normal pictures that can serve as references for anomaly detection.

There are cases in which many pictures are necessary for training a neural network included in an inference unit 10. In such cases, it is not rare for there to be difficulty in preparing natural pictures captured by a camera or the like. Meanwhile, since the neural network included in the inference unit 10 in the present embodiment is used in anomaly detection, there is no need for the pictures used in training to necessarily be natural pictures. As one example, training can be performed by using fractal pictures generated by a prescribed algorithm. Since fractal pictures are pictures including features and edges in arbitrary directions, they are suitable for neural networks used to detect anomalies in order to perform feature detection.

The inference unit 10 is not limited to the example of the case in which it is a VGG16. As the inference unit 10, for example, a RESNET50 may be used instead of a VGG16. A RESNET50 is a CNN configured so as to have a total of 50 convolution layers. The inference unit 10 may be composed of a single CNN or may be composed of multiple CNNs. In the case in which the inference unit 10 is composed of multiple CNNs, the inference unit 10 may be selectively switched between multiple deep learning models in accordance with the detection targets, or may be configured so that multiple deep learning models are combined.

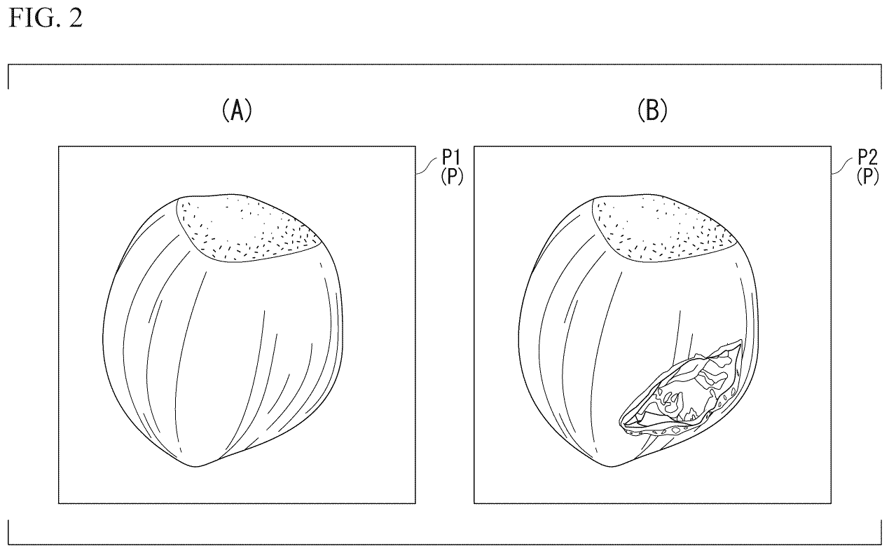

FIG. 2 is a diagram illustrating an example of a normal input picture and an anomalous input picture according to an embodiment. An example of the input pictures P will be explained with reference to said diagram.

FIG. 2(A) illustrates an input picture P1 as an example of a normal input picture. The input picture P1 is a captured picture of a nut. FIG. 2(B) illustrates an input picture P2 as an example of an anomalous input picture. The input picture P2 is also a captured picture of a nut like input picture P1, except that the nut in the input picture P2 has a crack. Therefore, the anomaly detection system 1 detects the nut having the crack to be anomalous.

Returning to FIG. 1, the anomaly detection unit 30 acquires at least one or more features maps F from the inference unit 10. The anomaly detection unit 30 performs anomaly detection based on the acquired feature maps F. The anomaly detection unit 30 outputs the results obtained by performing anomaly detection, as anomaly detection results R, to the information processing device 60.

The anomaly detection performed by the anomaly detection unit 30 may be detection of whether or not (i.e., a binary value) there is a flaw in the outer appearance of an object captured in an input picture P, or may be an estimation of locations at which there are flaws in the outer appearance of an object. The presence of a flaw in an object indicates that there is a specific difference from normal pictures on which the inference unit 10 has been pre-trained.

Additionally, the anomaly detection unit 30 may detect the degree of a flaw or the likelihood of a flaw in the outer appearance of an object captured in an input picture P.

Some or all of the functions of the inference unit 10 and the anomaly detection unit 30 may be realized by using hardware such as an ASIC (Application-Specific Integrated Circuit), a PLD (Programmable Logic Device) or an FPGA (Field-Programmable Gate Array).

For example, in order to configure the functions of the inference unit 10 and the anomaly detection unit 30, a processor for executing program processes may be combined with an accelerator for executing operations associated with a neural network. Specifically, a neural network operation accelerator for repeatedly executing convolution operations and quantization operations may be used in combination with the processor. In the description below, the inference unit 10 may sometimes be referred to as a backbone and the anomaly detection unit 30 may sometimes be referred to as a head.

The inference unit 10 and the anomaly detection unit 30 function as the inference unit 10 and the anomaly detection unit 30 by execution, respectively, of an inference program and an anomaly detection program. The inference program and the anomaly detection program may be recorded in a computer-readable recording medium. The computer-readable recording medium may, for example, be a portable medium such as a flexible disk, a magneto-optic disk, a ROM or a CD-ROM, or may be a storage device, such as a hard disk, internally provided in a computer system. A display screen control program may be transmitted via an electrical communication line.

The information processing device 60 acquires anomaly detection results R from the anomaly detection unit 30. The information processing device 60 may display pictures based on the acquired anomaly detection results R or may perform prescribed actions on corresponding objects based on the acquired anomaly detection results R. The prescribed actions may, for example, be actions or the like for removing flawed products from a manufacturing line, or may be actions or the like for saving inspection logs or the like based on the anomaly detection results R.

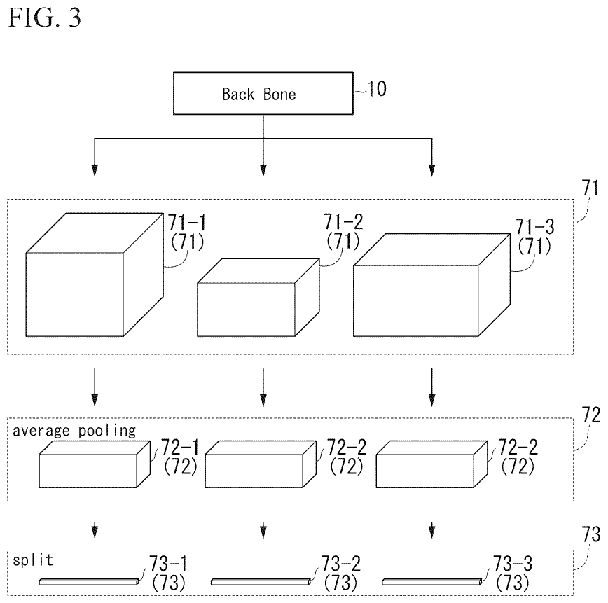

FIG. 3 is a diagram for explaining the concept of the anomaly detection system according to an embodiment. The concept of the anomaly detection system 1 will be explained with reference to said diagram.

First, in the example illustrated in said diagram, a feature map 71-1, a feature map 71-2, and a feature map 71-3 are extracted as feature maps 71 from different intermediate layers among the multiple intermediate layers provided in the inference unit 10.

There are case in which the multiple feature maps 71 acquired from the different intermediate layers are of respectively different sizes.

In the present embodiment, it is sufficient for the anomaly detection system 1 to perform operations based on one or more feature maps. However, more accurate anomaly detection can be performed based on multiple feature maps. An example of the case in which the operations are based on multiple feature maps will be explained. The feature maps have different characteristics, such as field of view and detection direction, depending on the intermediate layers from which they have been acquired. Therefore, the anomaly detection system 1 can detect anomalies based on various features by utilizing multiple feature maps.

Next, the anomaly detection system 1 compresses the multiple feature maps 71 that have been acquired.

The feature maps 71 are multi-dimensional data. Specifically, the feature maps 71 are four-dimensional tensors having the elements (i, j, c, n) as constituent elements. The i direction and the j direction are the picture directions in the input pictures P, i.e., the vertical direction and the horizontal direction in the input pictures P. The c direction is a channel direction. Channel directions include, for example, color (R, G, B) directions of pixels. The element n is information indicating one of the feature maps among the multiple feature maps.

The anomaly detection system 1 performs compression in the i direction and in the j direction (i.e., in the vertical direction and the horizontal direction in the input pictures P).

In this case, the acquired feature maps 71 respectively have different sizes. Therefore, the anomaly detection system 1 compresses the feature maps 71 so that the multiple feature maps 71 that have been acquired are of the same size in the i direction and the j direction.

The anomaly detection system 1 preferably performs compression in accordance with the feature maps 71 having the smallest sizes in the i direction and in the j direction. However, the anomaly detection system 1 may perform compression in accordance with the feature maps 71 having the largest sizes in the i direction and in the j direction, or may not perform compression.

There are cases in which the size of the feature maps 71 appropriate for anomaly detection changes depending on the detection target. For example, with industrial products such as mass-produced screws and electronic components, each individual item among the normal products has a substantially identical outer appearance, and the variation is relatively small. Meanwhile, with food products such as boxed lunches and frozen foods, and textile products such as fabric and clothing, there are cases in which the outer appearances are different for each individual item, even when the items are normal products, and the variation is relatively large.

For example, if the size of a feature map is made too large relative to detection targets with little variation in their outer appearances, there are cases in which small differences in outer appearances that are not actually anomalies could be erroneously detected as anomalies. Additionally, if the size of a feature map is made too small relative to detection targets with high variation in their outer appearances, there are cases in which they could be erroneously detected to lack anomalies despite actually having anomalies.

Therefore, in the anomaly detection system 1, the sizes of the feature maps 71 may be changed depending on the detection targets (i.e., the targets or states to be detected in the captured pictures). For example, the sizes of the feature maps may be made smaller for industrial products with little variation in their outer appearances, and the sizes of the feature maps may be made larger for food products or textile products with large variations in their outer appearances. Additionally, the sizes of the feature maps 71 may be made larger when detecting the states of industrial products that originally have little variation after being machine-mounted or machined. The detection accuracy can be raised by changing the sizes of the feature maps 71 in accordance with the targets to be detected. Additionally, as a result of setting appropriate sizes for the feature maps 71, when the sizes of the features maps 71 are small, the computation amount is reduced, and therefore, computational operations can be made faster. That is, according to the present embodiment, the detection accuracy may be improved and computational operations can be made faster.

The sizes of the feature maps 71 corresponding to the detection targets may be assessed at the time of training. For example, at the time of training, it may be learned which size, among multiple different feature map sizes, can result in accurate detection. Additionally, the system may be configured so that accuracies, etc. corresponding to the sizes of multiple different feature maps 71 are output, and the sizes of the feature maps 71 corresponding to the detection targets can be set as parameters by means of a UI (User Interface).

For example, the anomaly detection system 1 compresses the multiple feature maps 71 that have been acquired by means of a method such as average pooling or max pooling.

In the description below, feature maps 71 that have been compressed will be described as feature maps 72.

Next, the anomaly detection system 1 splits the feature maps 72 in the i direction and in the j direction. The anomaly detection system 1 may split the feature maps 72 into an odd number in the i direction and an odd number in the j direction. For example, the anomaly detection system 1 splits the feature maps 72 into seven in the i direction and into seven in the j direction, for a total of 49 regions.

Although the numbers of elements in the i direction and in the j direction in the compressed feature maps 72 are preferably made the same as the split numbers so that there is one element in the i direction and in the j direction in each split feature map 73, the present embodiment is not limited thereto. The computational load for anomaly detection can be reduced by splitting the feature maps 72 in the i direction or in the j direction.

In the description below, feature maps 72 that have been split will be described as feature maps 73.

Next, the anomaly detection system 1 calculates the distance between an input picture P and a pre-learned normal picture for each feature map 73. Specifically, the anomaly detection system 1 calculates the distance from the pre-learned normal picture by calculating the Mahalanobis distance, rather than the Euclidean distance, based on the values of the elements included in the feature map 73. The respective elements included in the feature map 73 are not each independent values, and in particular, the c-direction elements are feature quantities acquired based on outputs of the same picture, and thus can be expected to have some sort of correlation. As a result thereof, even in the case in which there is a characteristic diversity in normal pictures constituting a parent population, the anomaly detection system 1 can accurately calculate the distances between the normal pictures and anomalous pictures.

In the present embodiment, operations can be easily performed because Mahalanobis distances are calculated for each split feature map 73 rather than calculating the Mahalanobis distances for the entire input pictures P.

In this case, the feature maps are split because the computational amounts can be reduced by reducing the number of elements included in the feature maps by splitting them. In particular, by making the number of elements in the i direction and in the j direction in compressed feature maps 72 the same as the number into which they are split in the respective directions, the split feature maps 73 can be set to each have one element in the i direction and in the j direction. By setting the number of elements in the i direction and in the j direction to be one when computing the Mahalanobis distances, the computational load can be significantly reduced.

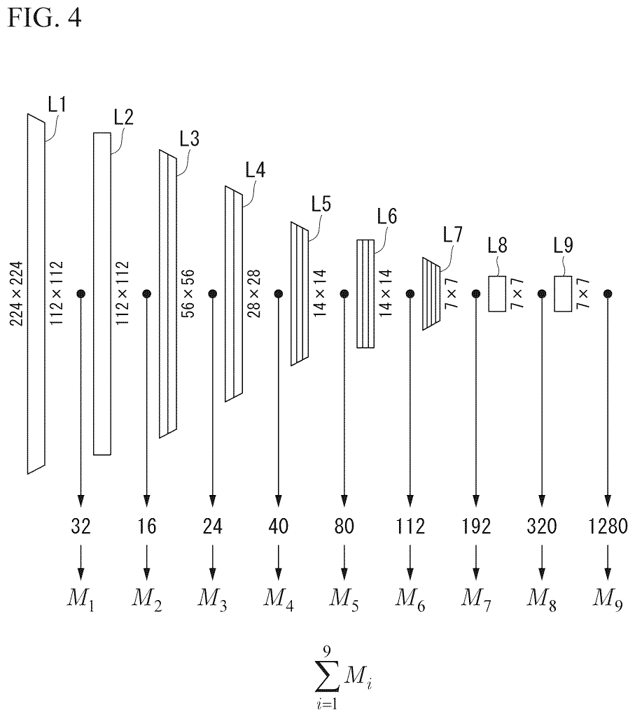

FIG. 4 is a diagram for explaining the layers provided in the inference unit according to an embodiment. The layers provided in the inference unit 10 will be explained with reference to said diagram.

The inference unit 10 has, for example, nine layers, from layer L1 to layer L9. In the example illustrated in said diagram, layer L1, layer L3, layer L4, layer L5, and layer L7 are pooling layers, and layer L2, layer L6, layer L8, and layer L9 are convolution layers. The anomaly detection system 1 extracts feature maps 71 from multiple different layers.

In the example illustrated in FIG. 4, the anomaly detection system 1 calculates the Mahalanobis distance M₁ based on the feature map F₁ extracted from layer L1, calculates the Mahalanobis distance M₂ based on the feature map F₂ extracted from layer L2, . . . , and calculates the Mahalanobis distance M₉ based on the feature map F₉ extracted from layer L9.

Since the anomaly detection system 1 calculates the Mahalanobis distances M after the extracted feature maps F have been split, a number of Mahalanobis distances in accordance with the split number is calculated for each feature map F.

The anomaly detection system 1 adds up the Mahalanobis distance M₁ to the Mahalanobis distance M₉ that have been calculated.

The anomaly detection system 1 does not need to add up all of the Mahalanobis distances calculated for each layer. For example, the anomaly detection system 1 may selectively add up large values of the Mahalanobis distance that have been calculated, or may apply weightings for weighted addition.

Additionally, the anomaly detection system 1 may be configured to calculate distribution information such as mean values or standard deviations instead of addition. According to the present embodiment, positions at which anomalies are detected within the pictures of detection targets can be identified by calculating the Mahalanobis distances after the feature maps have been split.

Since the anomaly detection system 1 splits extracted feature maps F in the picture directions, by adding the Mahalanobis distances M at corresponding picture positions, anomaly detection may be performed at those picture positions.

### [Functional Configuration of Anomaly Detection Unit]

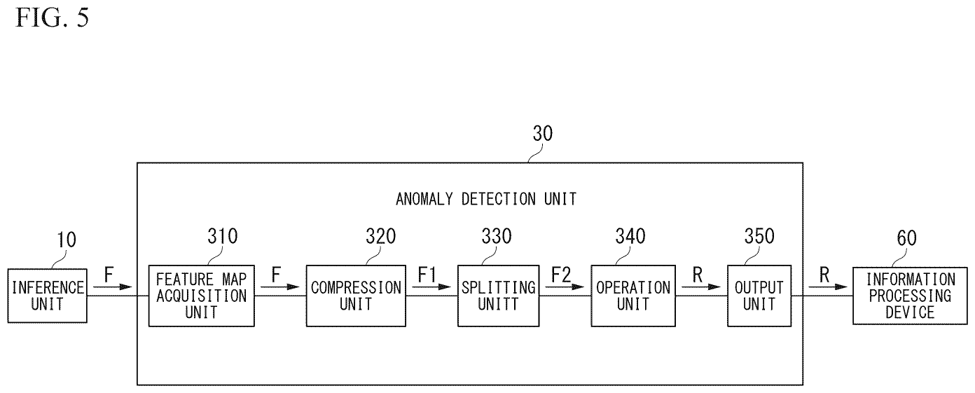

FIG. 5 is a functional configuration diagram illustrating an example of the functional configuration of an anomaly detection unit according to an embodiment. An example of the functional configuration of the anomaly detection unit 30 will be explained with reference to said diagram. The anomaly detection unit 30 is provided with a feature map acquisition unit 310, a compression unit 320, a splitting unit 330, an operation unit 340, and an output unit 350.

The feature map acquisition unit 310 acquires, from the inference unit 10, feature maps F extracted from input pictures P. The feature map acquisition unit 310 acquires multiple feature maps extracted from different intermediate layers among the multiple feature maps F extracted from the input pictures P by the inference unit 10. The feature map acquisition unit 310 transfers the acquired feature maps F to the compression unit 320.

The compression unit 320 compresses the acquired feature maps F. The feature maps F have at least the channel direction and the picture directions, including the vertical direction and the horizontal direction, as feature quantities. The compression unit 320 compresses the picture directions among the elements of the feature maps.

The compression unit 320 in the present embodiment does not compress the feature maps in the channel direction. Therefore, according to the compression unit 320, the information amount can be compressed while maintaining the information amount in the channel direction.

The compression unit 320 transfers the feature maps F that have been compressed, as feature maps F1, to the splitting unit 330.

The compression unit 320 may also be compressed in the c direction in order to reduce the data quantity as appropriate.

The splitting unit 330 splits the compressed feature maps F1. Specifically, the splitting unit 330 splits the feature maps F1 in the picture directions.

The splitting unit 330 preferably splits the feature maps F into odd numbers in both the vertical direction and the horizontal direction. Due to the splitting unit 330 splitting the feature maps F into odd numbers, median values can be obtained during the operations, thus facilitating the operations. However, they do not need to be necessarily split into odd numbers, and they may be split into even numbers in accordance with the data or applications to be detected.

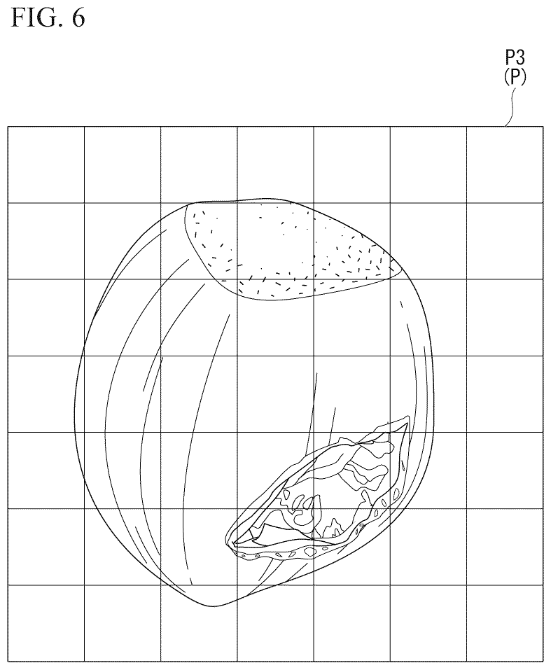

FIG. 6 is a diagram for explaining splitting according to an embodiment. The splitting of a feature map F1 will be explained with reference to said diagram. The picture P3 is an input picture P, and is an example indicating the positional relationships with respect to the input picture P when a feature map F1 is split in the picture directions by the splitting unit 330. In the example illustrated in said diagram, the splitting unit 330 splits the feature map F1 into seven in the vertical direction and into seven in the horizontal direction, for a total of 49 regions. That is, the splitting unit 330 splits the picture P3, which is the input picture, into seven in the vertical direction and into seven in the horizontal direction, for a total of 49 regions, and the anomaly detection system 1 performs operations for anomaly detection in each region into which the input picture has been split by the splitting unit 330.

In this case, the feature maps acquired from the intermediate layers, due to convolution operations, etc., include information beyond the regions into which the input pictures have been split. For this reason, anomalies can be detected with higher accuracy than that in the case of anomaly detection in which input pictures are simply split.

The division unit 330 transfers the feature maps F that have been split, as feature maps F₂, to the operation unit 340.

Returning to FIG. 5, the operation unit 340 performs operations based on mean value vectors and variances determined in advance for each of the split feature maps F₂. The operations based on mean value vectors and variances are specifically computations of the Mahalanobis distances. That is, the operation unit 340 computes the Mahalanobis distances as the operations based on the mean value vectors and variances for each of the split feature maps F₂.

Additionally, the operation unit computes the mean value vectors and the variances based on multiple feature maps F₂ that have been acquired.

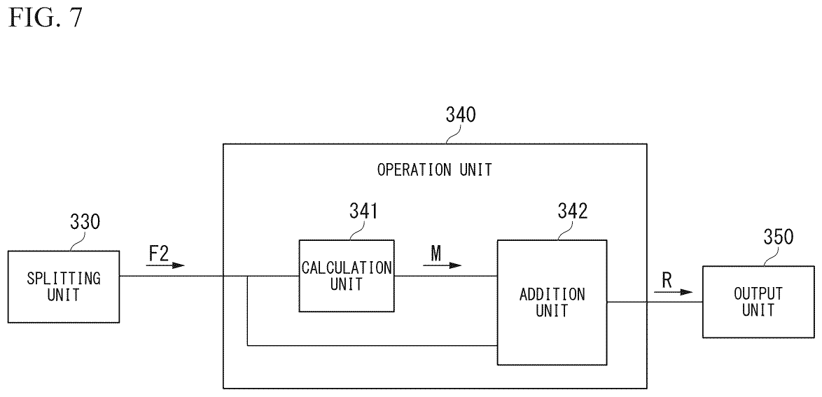

FIG. 7 is a functional configuration diagram illustrating an example of the functional configuration of the operation unit according to an embodiment. The functional configuration of the operation unit 340 will be explained with reference to said diagram. The operation unit 340 performs operations based on mean value vectors and variances for each of the split feature maps F₂ to perform anomaly detection in the input picture P. The operation unit 340 transfers results obtained by performing the operations to the output unit 350 as anomaly detection results R.

The operation unit 340 is provided with a calculation unit 341 and an addition unit 342.

The calculation unit 341 performs operations based on mean value vectors and variances for each of the multiple feature maps F₂ that have been split. The operations based on the mean value vectors and the variances specifically involve computing Mahalanobis distances based on Expression (1) below.

$$\begin{matrix}[ Mathematical Expression 1 ] & \\ {D}^{2} = {( x - m )}^{T} {C}^{- 1} ( x - m ) & ( 1 )\end{matrix}$$

wherein:
D²=Mahalanobis distance
x=Vector of data
m=Vector of mean values of independent variables
C⁻¹=Inverse Covariance matrix of independent variables
T=Indicates vector should be transposed

In this case, D² represents a Mahalanobis distance, x represents a vector comprising elements of the multiple split feature maps F₂ that are the computation targets, m represents a mean value vector that has been determined in advance, C⁻¹ represents an inverse matrix of a covariance matrix that has been determined in advance, and T represents a transposition operation. Although the Mahalanobis distances themselves may have a value from zero to infinity, they may be provided with an upper limit that is a value with 8 bits, 16 bits, etc., or they may be normalized. Although the Mahalanobis distances are indicated by D², which is a squared form, in order to simplify the computations, they may be in a non-exponential form.

The calculation unit 341 calculates, based on Expression (1) above, the Mahalanobis distances D² for each of the multiple feature maps F2 that have been split, and transfers the Mahalanobis distances D², which are the calculated results, to the addition unit 342 as Mahalanobis distances M.

As the inverse covariance matrix, a pseudo-inverse matrix may be used.

The addition unit 342 obtains anomaly detection results R by adding multiple calculated results based on prescribed conditions. The prescribed conditions may, for example, be to use the three highest values, etc., among the calculated Mahalanobis distances M.

Additionally, the addition unit 342 may add, among the values calculated by the calculation unit 341, values selected based on prescribed threshold values. Additionally, the addition unit 342 may obtain anomalous detection results R by taking mean values instead of adding multiple calculated results. Additionally, the addition unit 342 may obtain the anomaly detection results R by combining variances in addition to adding multiple calculated results.

Hereinafter, a specific example of the method for obtaining anomaly detection results R from the multiple calculated results will be explained. The anomaly detection results R may, for example, be obtained by performing statistical operations on the multiple calculated results. An example of a statistical operation is to extract the highest m (m being a natural number equal to or greater than 1) results among the multiple calculated results, and to calculate the sum, the mean value, the central value (median value), the mode, etc. of the extracted values. The targets of the statistical operations are not limited to the example of extraction from the highest m values, but also may be obtained by extraction of both the m highest and lowest values, by extraction of the remaining values after removing results that are a prescribed value (threshold value) or lower, or by extraction of values with a variance of a prescribed value (for example, 30) or higher. Additionally, instead of extracting targets of statistical operations from the multiple calculated results, the anomaly detection results R may be obtained by performing statistical operations based on multiple results. Additionally, instead of performing statistical operations on the multiple calculated results, the anomaly detection results R may be obtained by performing operations based on maximum values and minimum values of the multiple calculated results. For example, the anomaly detection results R may be obtained based on the differences between the maximum values and the minimum values of the multiple calculated results. The method of obtaining the anomaly detection results R from the multiple calculated results is not limited to the above-mentioned example, and it is possible to apply various known methods.

The addition unit 342 may, instead of adding the multiple calculated results, generate distributions based on the Mahalanobis distance results, and take the generated distributions as the anomaly detection results R.

Returning to FIG. 5, the output unit 350 outputs the anomaly detection results R, which are the results of the operations by the operation unit 340. The output unit 350, for example, outputs the anomaly detection results R to the information processing device 60.

### [Modified Example of Anomaly Detection Unit]

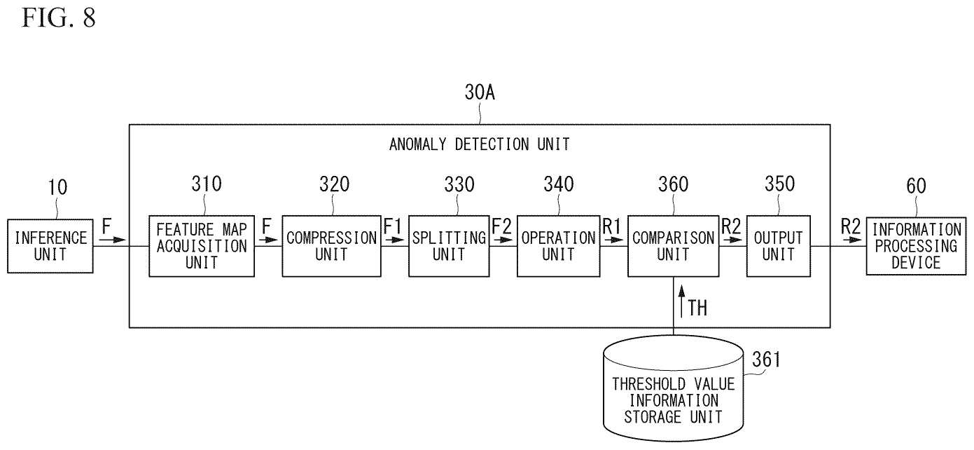

FIG. 8 is a functional configuration diagram illustrating a modified example of the functional configuration of the anomaly detection unit according to an embodiment. The anomaly detection unit 30A, which is a modified example of the anomaly detection unit 30, will be explained with reference to said diagram. The anomaly detection unit 30A calculates the degree of anomality in an input picture P based on anomaly detection results R computed by the operation unit 340. The degree of anomality in the input picture P may be the distance from a pre-learned normal picture.

The anomaly detection unit 30A differs from the anomaly detection unit 30 in that a comparison unit 360 and a threshold value information storage unit 361 are provided. Regarding features similar to those in the anomaly detection unit 30, explanations thereof may sometimes be omitted by appending the same reference numbers thereto. In the explanation in said diagram, the anomaly detection results R computed by the operation unit 340 are described as the anomaly detection results R1.

The comparison unit 360 acquires anomaly detection results R1 from the operation unit 340. Additionally, the comparison unit 360 acquires a prescribed threshold value TH from the threshold value information storage unit 361.

The comparison unit 360 compares the acquired anomaly detection results R1 with the prescribed threshold value TH. For example, if, as a result of comparison by the comparison unit 360, the acquired anomaly detection results R1 are greater than the prescribed threshold value TH, there is some sort of anomaly in an object captured in the input picture P. The output unit 350 outputs anomaly detection results R2, which are the results of the comparison by the comparison unit 360.

The prescribed threshold value TH stored in the threshold value information storage unit 361 may be divided into multiple stages. In this case, the comparison unit 360 compares the anomaly detection results R1, which are the results computed by the operation unit 340, with multiple prescribed threshold values TH to classify the anomaly detection results R1 into different levels. The comparison unit 360 can calculate the degrees of anomalies in the input pictures P by classifying the anomaly detection results R1 into the different levels. The comparison unit 360 outputs the results of classification into different levels to the output unit 350 as anomaly detection results R2.

The output unit 350 outputs the anomaly detection results R2, which are the classified results.

The prescribed threshold values TH stored in the threshold value information storage unit 361 may be set by the user before starting detection, or may be acquired as the results of a training process to be described below.

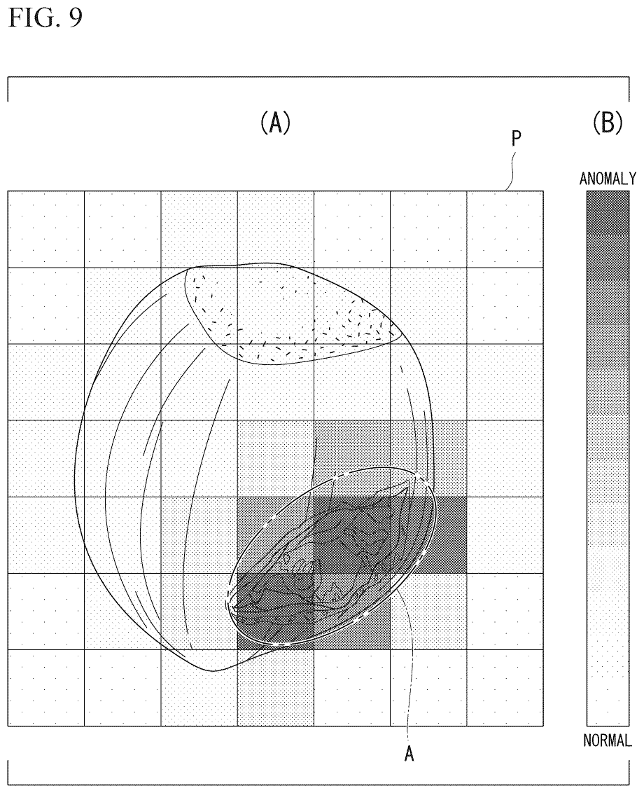

FIG. 9 is a diagram illustrating an example of output results from an output unit according to an embodiment. Display results based on the anomaly detection results R2, which are the results classified into different levels by the comparison unit 360, will be explained with reference to said diagram.

FIG. 9(A) illustrates an example of a displayed picture that has been color-coded for the degree of anomality in accordance with the position in the input picture P. FIG. 9(B) illustrates an example of a legend for the color-coding. In said diagram, the areas estimated to be anomalous are indicated in darker colors, and the areas estimated to be normal are indicated in lighter colors. The portion indicated by the reference symbol A is estimated to be anomalous, and is thus indicated by a darker color.

The comparison unit 360 may determine whether or not objects captured in input pictures P are to be removed from a manufacturing line by comparing the anomaly detection results R1 with the prescribed threshold value TH. In this case, the anomaly detection system 1 may set multiple-level threshold values, thereby distinguishing between and removing objects captured in the input pictures P at multiple areas in accordance with the degree of anomality.

### [Series of Operations in Anomaly Detection System]

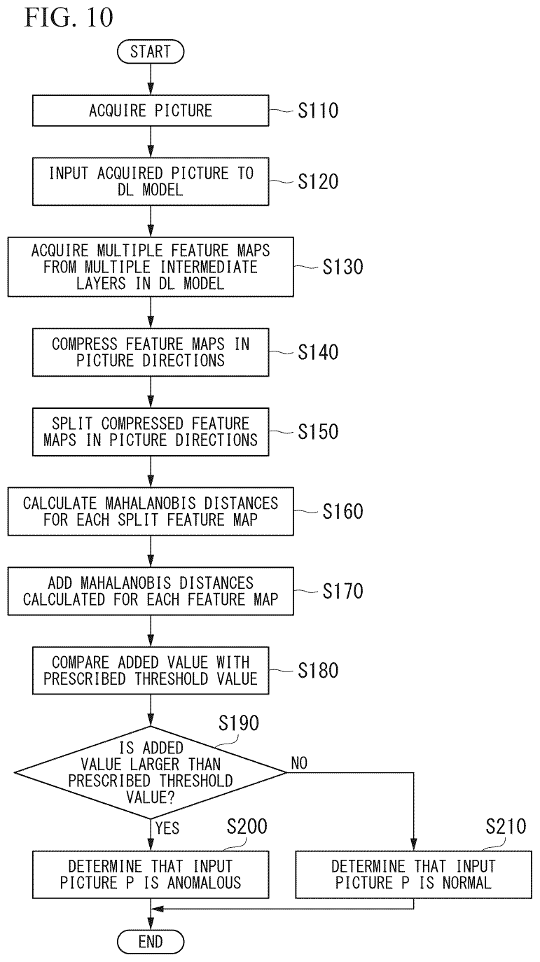

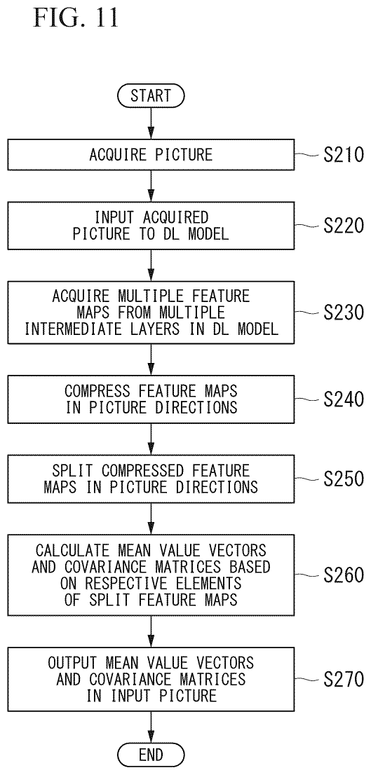

Next, a series of operations for “detection” and “training” in the anomaly detection system according to an embodiment will be described with reference to FIG. 10 and FIG. 11.

FIG. 10 is a flow chart for explaining a series of operations in a “detection” process in an anomaly detection system according to an embodiment. The series of operations in the anomaly detection system 1 will be explained with reference to said diagram.
(Step S110) First, the anomaly detection system 1 acquires an input picture P. The anomaly detection system 1 acquires the input picture P, for example, from an image capture device 50.
(Step S120) The anomaly detection system 1 inputs the acquired picture to a DL (Deep Learning) model, i.e., to the inference unit 10.
(Step S130) The feature map acquisition unit 310 provided in the anomaly detection unit 30 acquires feature maps F from each of multiple intermediate layers in the DL model.
(Step S140) The compression unit 320 provided in the anomaly detection unit 30 compresses the acquired feature maps F in the picture directions.
(Step S150) The splitting unit 330 provided in the anomaly detection unit 30 splits the compressed feature maps in the picture directions.
(Step S160) The operation unit 340 provided in the anomaly detection unit 30 calculates the Mahalanobis distances M for each of the split feature maps.
(Step S170) The operation unit 340 provided in the anomaly detection unit 30 adds the Mahalanobis distances M determined for each feature map.
(Step S180) The comparison unit 360 compares the added value with a prescribed threshold value.
(Step S190) In the case in which the added value is larger than the prescribed threshold value (i.e., step S190; YES), the comparison unit 360 advances the process to step S200. Additionally, in the case in which the added value is not larger than the prescribed threshold value (i.e., step S190; NO), the comparison unit 360 advances the process to step S210.
(Step S200) The input picture P is determined to have an anomaly, and the output unit 350 outputs such a result to the information processing device 60.
(Step S210) The input picture P is determined to be normal, and the output unit 350 outputs such a result to the information processing device 60.

FIG. 11 is a flow chart for explaining a series of operations in a “training” process in an anomaly detection system according to an embodiment. The training operations in the anomaly detection system 1 will be explained with reference to said diagram.
(Step S210) First, the anomaly detection system 1 acquires an input picture P. The anomaly detection system 1 acquires the input picture P, for example, from an image capture device 50. In the case in which a training operation is being performed, control is implemented to select and acquire only normal pictures. In other words, the anomaly detection system 1 assumes pictures provided when performing the training operation to be normal pictures, and detects anomalies in input pictures P by calculating the deviation from the normal pictures as the Mahalanobis distances.
(Step S220)

The anomaly detection system 1 inputs the acquired picture to a DL model, i.e., to the inference unit 10.
(Step S230) The feature map acquisition unit 310 provided in the anomaly detection unit 30 acquires feature maps F from each of the multiple intermediate layers in the DL model.
(Step S240) The compression unit 320 provided in the anomaly detection unit 30 compresses the acquired feature maps F in the picture directions.
(Step S250) The splitting unit 330 provided in the anomaly detection unit 30 splits the compressed feature maps in the picture directions.
(Step S260) A parameter calculation unit, not illustrated, provided in the anomaly detection unit 30 calculates parameters to be used in the operations by the operation unit 340 based on the respective elements in the feature maps that have been split. In this case, the parameters used in the operations by the operation unit 340 are specifically mean value vectors and covariance matrices in a normal picture. Although the mean value vectors and the covariance matrices in the normal picture are split, in order to reduce the computational load, step S250 may be skipped and they may be determined for the entire picture.

That is, the feature map acquisition unit 310 acquires multiple feature maps extracted from at least one normal picture, and the parameter calculation unit calculates the parameters based on multiple feature maps extracted from the normal picture. The parameters may include mean value vectors and covariance matrices.
(Step S270) The mean value vectors and the covariance matrices in the input picture P are output. The mean value vectors and the covariance matrices that have been output are parameters generated from normal pictures in advance, and are used in the detection operation as the parameters determined in advance.

In order to simplify the explanation, an example in which the training operation is performed based on a single input picture P was indicated. However, the anomaly detection system 1 preferably determines the mean value vectors and the covariance matrices by using several tens of pictures. Additionally, in the case in which the anomaly detection system 1 is used in a product inspection system, etc., said training operation is preferably performed in accordance with images of targets contained in the input picture P. The training operations performed in accordance with images of targets contained in the input picture P may be performed by the product line, the inspection type, etc.

Additionally, the training operation must be performed before the detection operation indicated in FIG. 10. Furthermore, said training operation is preferably performed periodically. In this case, the anomaly detection system 1 may provide a prompt to perform retraining after a prescribed period has elapsed since a training operation was performed.

Additionally, in the training operation in the present embodiment, a backbone is not trained. By separately performing backbone training, which requires many pictures for training, the training associated with anomaly detection can be completed with a small number of pictures and with little training time. However, in the case in which training time can be secured, additional training or the like may be performed for the backbone by using normal pictures.

In step S260, a threshold value for detecting anomalies may be calculated when calculating the mean value vectors and the covariance matrices in the normal picture. Specifically, it may be determined automatically based on the variation in the Mahalanobis distances in the normal picture calculated when executing the training process.

### [Summary of Anomaly Detection System]

According to the embodiment described above, the anomaly detection system 1 detects anomalies based on feature maps F extracted from the input picture P by being provided with the anomaly detection unit 30. Specifically, the anomaly detection unit 30 acquires feature maps F by being provided with the feature map acquisition unit 310, compresses the acquired feature maps F by being provided with the compression unit 320, splits the compressed feature maps F by being provided with the splitting unit 330, and performs operations based on mean value vectors and variances for each of the compressed and split feature maps F. The anomaly detection unit 30 can easily execute computations in order to perform operations based on mean value vectors and variances for each feature map F that has been compressed and split. Therefore, according to the anomaly detection system 1, the presence or absence of anomalies in objects can be easily detected from picture information of input pictures P.

Additionally, according to the embodiment described above, the compression unit 320 compresses the feature maps F in the picture directions. Therefore, the anomaly detection unit 30 can reduce the processing load on the operation unit 340 by being provided with the compression unit 320.

In this case, in anomaly detection technology for objects, there are cases in which processing speed is required more than the identification accuracy of locations at which there are anomalies. According to the present embodiment, anomalies can be detected at a high speed by means of a tradeoff with the identification accuracy of locations at which there are anomalies because compression is performed in the picture directions.

Additionally, according to the embodiment described above, the splitting unit 330 splits the feature maps F into an odd number. In the case in which the feature maps F are split into an even number, there is no central value, and there are cases in which the computations can become complicated. According to the present embodiment, the splitting unit 330 splits the feature maps F into an odd number, and therefore, the operation unit 340 can easily perform operations for detecting anomalies.

Additionally, according to the embodiment described above, the compression unit 320 does not compress the feature maps F in the channel direction. Therefore, according to the compression unit 320, compression can be performed in the picture directions while maintaining the amount of information in the channel direction. Since the operation unit 340 performs operations based on the feature maps F after compression, the processing load in the picture directions can be reduced while maintaining the accuracy in the channel direction.

In anomaly detection technology for objects, there are cases in which accuracy regarding the presence or absence of anomalies is required more than the identification accuracy of the locations of the anomalies. Additionally, there are cases in which processing speed is required more than identification accuracy of the locations of anomalies. According to the present embodiment, since the compression is performed in the picture directions, anomalies can be detected at a high speed while maintaining accuracy regarding the presence or absence of the anomalies by means of a tradeoff with the identification accuracy of the locations of the anomalies because compression is performed in the picture directions.

Additionally, according to the embodiment described above, the operation unit 340 computes the Mahalanobis distances as the operations based on the mean value vectors and the variances for each of the feature maps F that have been split. Specifically, the operation unit 340 performs operations based on Expression (1) above. Therefore, with the operation unit 340, operations can be easily performed.

Additionally, according to the embodiment described above, the feature map acquisition unit 310 acquires multiple feature maps F extracted from different intermediate layers among the multiple feature maps F extracted from the input pictures P. Additionally, the operation unit 340 performs the operations based on the mean value vectors and the variances on the basis of the multiple feature maps that have been acquired.

Therefore, according to the present embodiment, the feature maps F can be acquired from many intermediate layers in the case in which accuracy is to be emphasized, and the feature maps F can be acquired from few intermediate layers in the case in which speed is to be emphasized. Thus, according to the present embodiment, it is possible to set which is to be emphasized in the tradeoff between the accuracy of anomaly detection and the processing speed.

Additionally, according to the embodiment described above, the operation unit 340, by being provided with the calculation unit 341, performs operations based on the mean value vectors and the variances for each of the multiple feature maps F extracted from different intermediate layers. Additionally, the operation unit 340 adds the values calculated for each of the feature maps F by being provided with an adding unit 342. Therefore, according to the present embodiment, the operation unit 340 can perform operations based on values calculated for each of multiple different feature quantities, and can thus more accurately detect anomalies.

Additionally, according to the embodiment described above, the addition unit 342 adds values that are selected, based on the prescribed threshold value, from among the values calculated by the calculation unit 341. That is, according to the present embodiment, anomaly detection is performed based on specific values among the calculated values. Therefore, according to the present embodiment, feature quantities not contributing to anomaly detection can be removed from the operations. Thus, according to the present embodiment, anomalies can be detected at high speed and with good accuracy.

Additionally, according to the embodiment described above, the value computed by the operation unit 340 is compared with a prescribed threshold value by being provided with a comparison unit 360. Therefore, according to the present embodiment, the results of anomaly detection can be output.

Additionally, according to the embodiment described above, the comparison unit 360 classifies the results computed by the operation unit 340 into different levels. The output unit 350 outputs results classified into different levels. Therefore, according to the present embodiment, display pictures in which anomaly locations can easily be visually identified can be output.

Additionally, according to the embodiment described above, the inference unit 10 is a neural network that has been trained to predict the classes and likelihoods of objects included in input pictures P. Therefore, according to the inference unit 10, feature maps F can be quickly extracted from the input pictures P. Additionally, the anomaly detection system 1 can detect anomalies without training in accordance with objects that are to be targets of anomaly detection by using a pre-trained neural network.

### [Summary of Anomaly Display System]

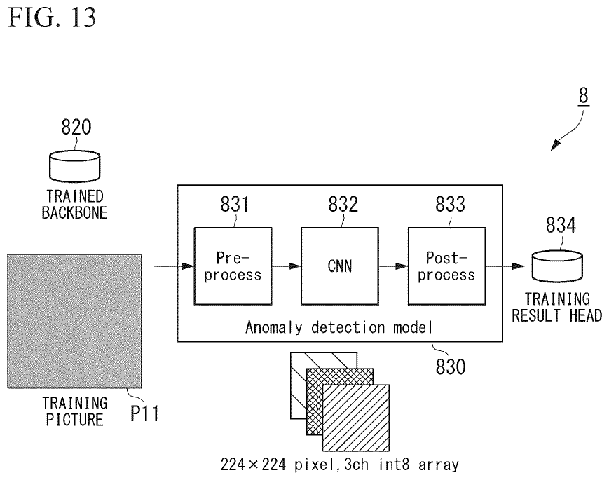

Next, the anomaly display system 8 will be explained with reference to FIG. 13 to FIG. 23. The anomaly display system 8 is a system for displaying anomalous locations in input pictures P by using an anomaly detection system 1.

In the explanation below, the anomaly display system 8 is used, for example, by a worker performing maintenance on a target such as infrastructure equipment. In the present embodiment, infrastructure equipment may be, for example, clean-water and sewage pipes, gas pipes, power transmission equipment, communication equipment, roads for automobiles, railway lines, etc. Additionally, the worker may be a person inspecting a target such as a home or an automobile.

Additionally, instead of the example of the case of use by a worker, the anomaly display system 8 may be used by a mobile body such as a drone or an AGV (automated guided vehicle). In this case, the anomaly display system 8 may perform anomaly detection based on images captured by the mobile body, and may display anomalous locations to an operator controlling a controller or a central control device.

The anomaly display system 8 is not limited to the example of the case of use by a worker or a mobile body such as a drone to inspect equipment or the like, and may be stationary in a manufacturing plant. The anomaly display system 8 provided in the manufacturing plant may detect anomalies in the outer appearances of products or components that have been manufactured and may display the detected results to an operator. Additionally, the anomaly display system 8 may be installed in a food processing plant, etc. to detect anomalies in the outer appearances of food products, materials, etc., and may be used to perform pre-shipment inspection by displaying the detected results to an operator.

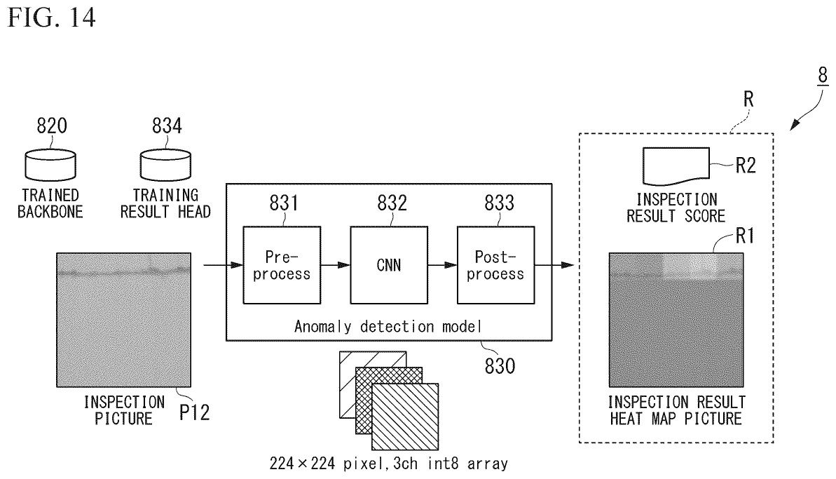

The anomaly display system 8 performs “training” and “inspection”. The “training” refers to learning the range of normal pictures based on normal pictures, and the “inspection” refers to performing anomaly detection of the outer appearances of input pictures P that are inspection targets based on the range of normal pictures that has been learned. First, “training” will be explained with reference to FIG. 13, and next, “inspection” will be explained with reference to FIG. 14.

FIG. 13 is a diagram for explaining the training process in the anomaly display device according to an embodiment. The “training” performed by the anomaly display system 8 will be explained with reference to said diagram. The anomaly display system 8 is provided with an anomaly detection model 830. A pre-trained backbone 820 and training pictures P11 are input to the anomaly detection model 830. The anomaly detection model 830 is trained based on the pre-trained backbone 820 and the training pictures P11, and outputs a training result head 834 as a result of the training.

The pre-trained backbone 820 is an example of the inference unit 10, and the training pictures P11 are an example of the input pictures P.

The anomaly detection model 830 is provided with a pre-process 831, a CNN (convolutional neural network) 832, and a post-process 833. The anomaly detection model 830 is an example of an anomaly detection unit 30.

Some or all of the processing in the anomaly detection model 830 may be implemented by a hardware accelerator.

The pre-process 31 calculates positional coordinates indicating ranges in which objects are predicted to be located in the input pictures P, and likelihoods of classes corresponding to the positional coordinates. The pre-process 831 performs processing for each element matrix into which input pictures P are split in the picture directions. That is, the pre-process 831 outputs positional coordinates indicating ranges in which objects are predicted to be located and the likelihoods of classes corresponding to the positional coordinates for each element matrix.

The CNN 832 performs convolution operations regarding the positional coordinates and likelihoods output by the pre-process 831. The CNN 832 may perform operations for each element matrix, and may output the results of multiple operations performed for each element matrix. For example, in the case in which the input pictures P have a picture size of 224 [pixels]×224 [pixels], an element matrix may have a picture size of 7 [pixels]×7 [pixels], which is the result of splitting into 32×32 regions. Additionally, the input pictures P may have 3 [ch (channel)]×8 [bit] color information comprising R (red), G (green), and B (blue) at the time of being input to the anomaly detection model 830.

The post-process 833 learns mean value vectors and covariance matrices in the input pictures P based on the operation results for each of the multiple element matrices output by the CNN 832. The post-process 833 outputs the training results as a training result head 834. That is, the training result head 834 is a pre-trained model. During the training process, it is preferable to use multiple pictures as the input pictures P. The input pictures P used in the training process are preferably normal pictures (including pictures that can be tolerated as being normal).

The pre-process 831 may perform prescribed picture processing instead of calculating positional coordinates indicating the ranges in which objects are predicted to be located in the input pictures P and the likelihoods of classes corresponding to said positional coordinates. As one example, a process for improving the picture quality of input pictures P, a process for modifying the pictures themselves, other data processing, etc. are included. The process for improving the picture quality may be a process such as brightness/color conversion, black level adjustment, noise improvement, or correction of optical aberration. The process for modifying the pictures themselves may be a process such as cutting out, enlarging, reducing, or deforming the pictures. The other data processing may be data processing such as tone reduction, compression coding/decoding, or data reproduction.

FIG. 14 is a diagram for explaining an inspection process in an anomaly display device according to an embodiment. The “inspection” performed by the anomaly display system 8 will be explained with reference to said diagram. In the anomaly display system 8, a pre-trained backbone 820, a training result head 834 learned during the “training” stage, and inspection target pictures P12 are input to the anomaly detection model 830. The anomaly detection model 830 outputs at least one of inspection result heat map pictures R1 or inspection result scores R2 as the anomaly detection results R.

The inspection result heat map pictures R1 may be the anomaly detection results R explained in connection with the anomaly detection system 1. The inspection result heat map pictures R1 are pictures in which information based on the results of anomaly detection are displayed in overlay on input pictures P. The inspection result heat map pictures R1 are one example of an embodiment, and may be displayed by methods other than a heat map.

The inspection result scores R2 may be the total processing time required for the inspection, the number of pictures inspected, paths indicating the storage locations of inspection results, etc.

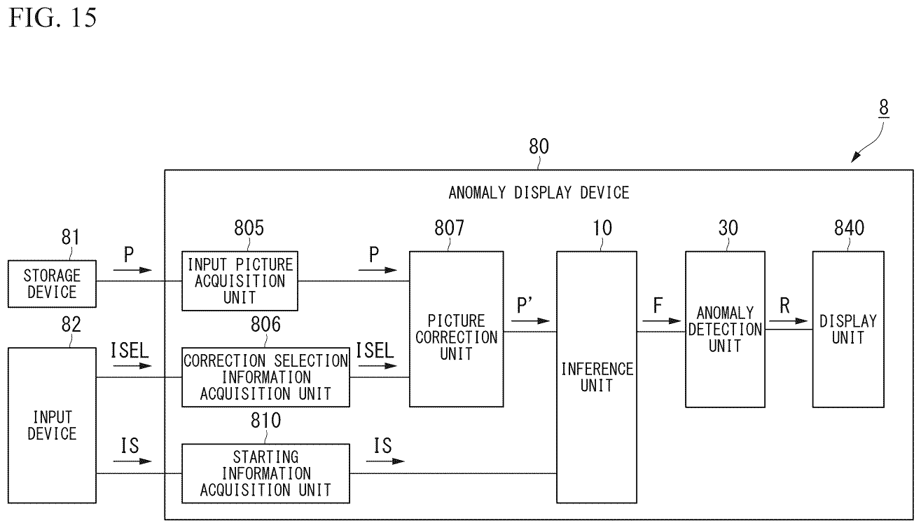

FIG. 15 is a functional configuration diagram illustrating an example of the functional configuration of an anomaly display device according to an embodiment. An example of the functional configuration of the anomaly display system 8 and the anomaly display device 80 according to the present embodiment will be explained with reference to said diagram. The respective blocks included in the anomaly display system 8 are controlled by a processor, which is not illustrated. Additionally, at least part of each bock may be realized by the processor executing a program stored in a memory, which is not illustrated.

The anomaly display system 8 is provided with a storage device 81, an input device 82, and an anomaly display device 80. The storage device 81 stores input pictures P (training pictures P11 and inspection target pictures P12), etc. The storage device 81 outputs the input pictures P to the anomaly display device 80. The anomaly display device 80 is “trained” based on the input pictures P that are normal pictures, and “inspects” the input pictures P that are inspection targets, and displays the results thereof. The input device 82 inputs information acquired from a user, based on operations by the user, to the anomaly display device 80. The input device 82 may, for example, be an input device such as a keyboard, a touch panel, or an audio input device.

The input device 82 may not be based on operations by a user. For example, information may be input periodically, or information may be input with object detection, etc. as a trigger.

The anomaly display device 80 is provided with a starting information acquisition unit 810, an input picture acquisition unit 805, a correction selection information acquisition unit 806, a picture correction unit 807, an inference unit 10, an anomaly detection unit 30, and a display unit 840. Regarding features that are similar to those in the anomaly detection system 1, explanations thereof may sometimes be omitted by appending the same reference numbers thereto.

The starting information acquisition unit 810 acquires starting information IS. The starting information IS includes information for making the anomaly detection unit 30 start anomaly detection. Anomaly detection involves detecting anomalies in the outer appearances of images included in input pictures P. For example, the starting information acquisition unit 810 may acquire starting information IS by means of operations by a user using the anomaly display system 8.

Additionally, the starting information IS may include information indicating either whether the anomaly detection unit 30 is to perform “training” based on prescribed normal pictures or is to execute “inspection (anomaly detection)”. The information indicating whether to perform “training” or “inspection” is also described as training execution selection information. That is, the starting information IS may also include training execution selection information.

The anomaly detection unit 30 executes either “training” or “inspection” based on the training execution selection information included in the starting information IS.

The input picture acquisition unit 805 acquires input pictures P. For example, the starting information IS acquired by the starting information acquisition unit 810 includes paths indicating locations at which input pictures P are stored, and the input picture acquisition unit 805 acquires the input pictures P stored at the locations indicated by said paths. The input pictures P may be stored in the storage device 81.

Although an example in which the input pictures P are designated by paths was indicated in the present embodiment, they may be acquired by being selectively designated in folders, etc. in which multiple pictures are held.

The picture correction unit 807 corrects the input pictures P acquired by the input picture acquisition unit 805 by picture processing. The picture correction unit 807 outputs the corrected input pictures P to the inference unit 10 as input pictures P′. The picture processing performed by the picture correction unit 807 will also be referred to as a correction process.

The correction selection information acquisition unit 806 acquires correction selection information ISEL. The correction selection information ISEL is information for selecting the type of correction process to be executed by the picture correction unit 807. The picture correction unit 807 performs a correction process in accordance with the type of correction process indicated by the correction selection information ISEL.

In the case in which the correction selection information ISEL includes information indicating that the pictures are not to be corrected, the correction selection information acquisition unit 806 may not correct the input pictures P.

The anomaly display system 8 may be provided with an image capture unit (image capture device), which is not illustrated. In the case in which the anomaly display system 8 is provided with an image capture unit, the starting information IS may include an image capture starting signal for making the image capture unit capture images. The starting information acquisition unit 810 may acquire the starting information IS when an image capture button, not illustrated, is operated by a user.

In the case in which the anomaly display system 8 is provided with an image capture unit, the input picture acquisition unit 805 acquires input pictures P in which images are captured by the image capture unit.

When the starting information IS is acquired, the inference unit 10 extracts feature maps F from the corrected input pictures P′. The inference unit 10 outputs the extracted feature maps F. The inference unit 10 outputs multiple feature maps F from the multiple intermediate layers.

Based on the acquired starting information IS, the anomaly detection unit 30 executes anomaly detection by comparing the acquired input pictures P or the corrected input pictures P′ with information that is based on pre-stored normal pictures. The information based on the pre-stored normal pictures may be information learned based on the training pictures P11.

The anomaly detection unit 30 may be a neural network pre-trained by the prescribed normal pictures.

The display unit 840 displays the information based on the information detected by the anomaly detection unit 30 in overlay on the input pictures P. For example, the display unit 840 displays an inspection result heat map picture R1 by displaying a prescribed color filter in overlay on an input picture P. The prescribed color filter may be color-coded so as to be able to visually determine locations at which anomalies have been detected.

Alternatively, the display unit 840 may display the input picture P by a method allowing the identification of portions in which there is a high probability that anomalies are located.

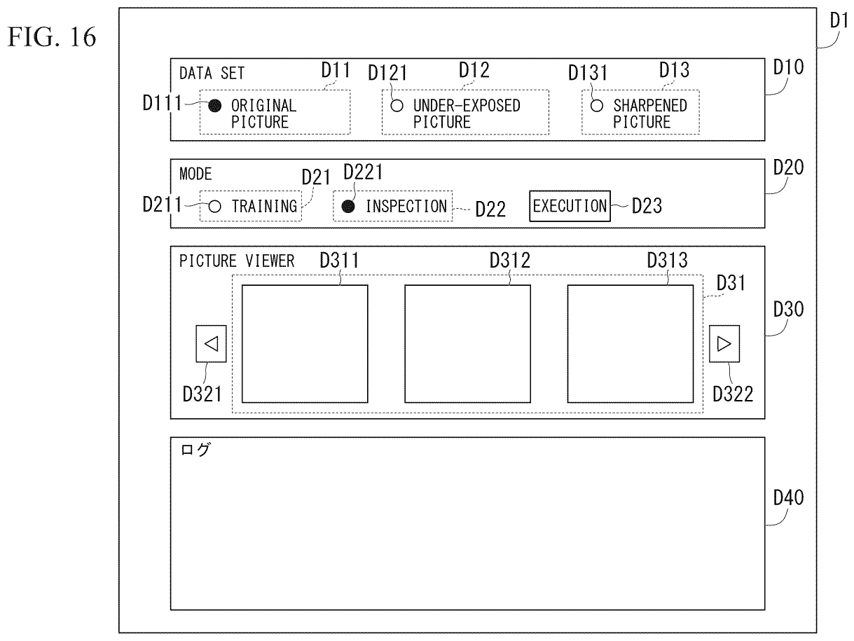

FIG. 16 is a diagram illustrating an example of a screen configuration for a display screen of an anomaly display device according to an embodiment. An example of a screen configuration of a display screen D1 displayed by the anomaly display device 80 will be explained with reference to said diagram. The anomaly display device 80 is operated by a user. The user operates the anomaly display device 80 by performing operations based on the information displayed on the display screen D1.

The display screen D1 indicates an example of a screen configuration of a display screen displayed by the anomaly display device 80. The display screen displayed by the anomaly display device 80 has a screen configuration with a data set display portion D10, a mode display portion D20, a picture display portion D30, and a log information display portion D40.

The data set display portion D10 is a screen feature for selecting corrections to the input pictures P. The data set display portion D10 is provided with reference number D11, reference number D12, and reference number 13 as screen features. Reference number D11, reference number D12, and reference number D13 are provided, respectively, with a selection button D111, a selection button D121, and a selection button D131. When making no distinction between the selection buttons among the selection button D111, the selection button D121, and the selection button D131, they may simply be described as selection buttons.

The user selects whether or not to correct an input picture P by selecting one of the selection buttons. The anomaly display device 80 performs “training” or “inspection” on the input picture P after having performed the selected correction. In the example illustrated in FIG. 16, examples of the correction include “original picture”, “under-exposed picture”, and “sharpened picture”.

The “original picture” means that the input picture P is not corrected. The “under-exposed picture” means that an exposure correction process is performed on the input picture P. The “sharpened picture” means that an image sharpening process is performed on the input picture P.

The correction process that the anomaly display device 80 performs on the input pictures P is performed by the picture correction unit 807. The types of processes by which correction can be performed by the picture correction unit 807 are not limited to the examples mentioned above, and may include histogram conversion processes such as “contrast correction”, “brightness correction”, and “color correction”, filter processes such as “noise removal” and “edge enhancement”, affine transformation, etc.

The mode display portion D20 is a picture feature for a user to select either “training” or “inspection”. The mode display portion D20 is provided with reference number D21, reference number D22, and an execute button D23 as screen features. Reference number D21 and reference number D22 are respectively provided with a selection button D211 and a selection button D221. The user selects “training” by selecting selection button D211, and selects “inspection” by selecting selection button D221. By operating the execute button D23, the user causes the selected “training” or “inspection” to be executed. In this case, the starting information acquisition unit 810 may acquire starting information IS including information on the selection conditions for the selection button due to selection of the execute button D23.

The “inspection” may include a “batch processing mode” and a “sequential processing mode”. In the “batch processing mode”, multiple input pictures P are processed in a single batch. In the “sequential processing mode”, the input pictures P are processed one at a time.

The picture display portion D30 displays at least one of the input pictures P used for “training” or the anomaly detection results R obtained as a result of anomaly detection by the “inspection”. The picture display portion D30 is provided with a picture display box D31, a left scroll button D321, and a right scroll button D322. The picture display box D31 displays pictures at the three locations indicated by reference number D311, reference number D312, and reference number D313. When three or more pictures are displayed, the user can view any three pictures among four or more pictures by operating the left scroll button D321 or the right scroll button D322. In this example, the picture display box D31 displays three pictures, but the number of pictures displayed by the picture display box D31 is not limited to this example.

The log information display portion D40 displays the results of the “training” or the “inspection”. For example, in the case of “training”, the log information display portion D40 displays the number of training pictures, the processing time per picture, the total processing time, the training result head, etc. For example, in the case of “inspection”, the log information display portion D40 outputs the number of inspected pictures, the processing time per picture, the total processing time, the inspection results, the storage locations (paths) of the inspection result pictures, etc.

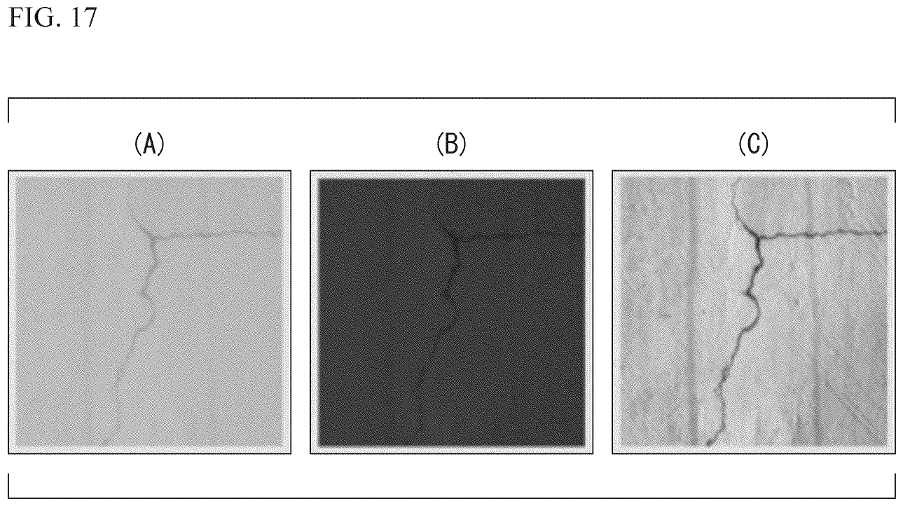

Next, an example of an input picture P displayed by the picture display portion D30 will be explained with reference to FIG. 17 to FIG. 19.

FIG. 17 is a diagram illustrating an example of picture correction of an input picture according to an embodiment. An example of an input picture P displayed by the picture display portion D30 in the “training” process will be explained with reference to said diagram. The picture display portion D30 displays three different input pictures P (also described as a data set in the explanation below) among the multiple input pictures P that are to be learned.

The pictures indicated in FIG. 17(A) to FIG. 17(C) are all tile pictures, and are pictures based on the same input picture P.

FIG. 17(A) is an input picture P′ for the case in which reference number D111 has been selected, i.e., a picture that has not been corrected. FIG. 17(B) is an input picture P′ for the case in which reference number D121 has been selected, i.e., a picture for the case in which the exposure has been corrected by the picture correction unit 807. FIG. 16(C) is an input picture P′ for the case in which reference number D131 has been selected, i.e., a picture for the case in which a picture sharpening process has been performed by the picture correction unit 807.

As another embodiment, the picture display portion D30 may display the same photograph for the cases in which different filters have been employed (for example, FIG. 17(A) to FIG. 17(C)) on the picture display portion D30, and have the user select a type of filter.

In the case in which a prescribed filter type has been selected, it is preferable to use the same filter for both the “training” and “inspection” processes. In this case, information regarding which type of filter was selected during the “training” process may be stored together with the training results. Additionally, “training” and “inspection” may be performed by using multiple filters, and a selection can be made therefrom. For example, the anomaly detection unit 30 may be configured to use multiple filters in advance and to perform “training” with each filter, then to perform “inspection” by using a learning model in accordance with the filter selected at the time of “inspection”.

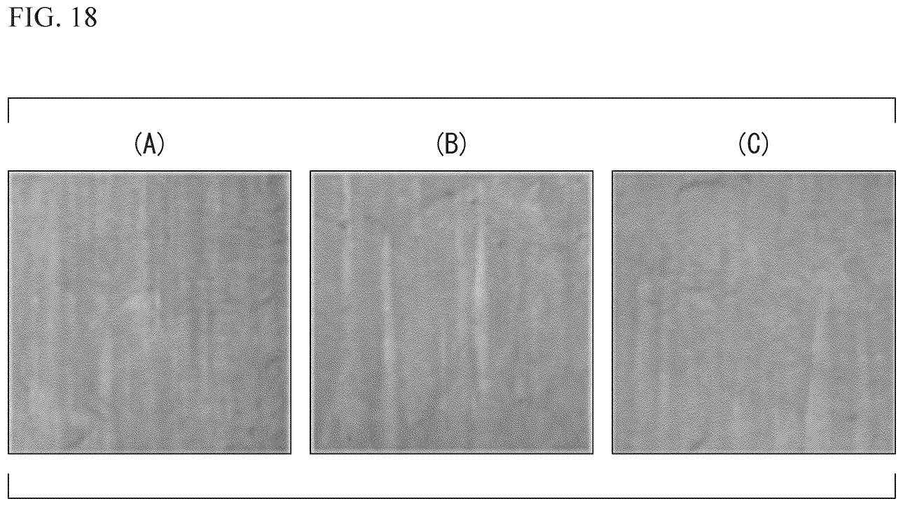

FIG. 18 is a diagram illustrating examples of normal pictures according to an embodiment. An example of input pictures P displayed by the picture display portion D30 in a “training” process will be explained with reference to said diagram. The picture display portion D30 displays three different input pictures P among a data set. The pictures illustrated in FIG. 18 (A) to FIG. 18(C) are all tile pictures and are pictures of different input pictures P. FIG. 18(A) to FIG. 18(C) are all pictures that have not been corrected by the picture correction unit 807.

The picture display portion D30, for example, displays the diagram illustrated in FIG. 18(A) at reference number D311, displays the diagram illustrated in FIG. 18(B) at reference number D312, and displays the diagram illustrated in FIG. 18(C) at reference number D313.

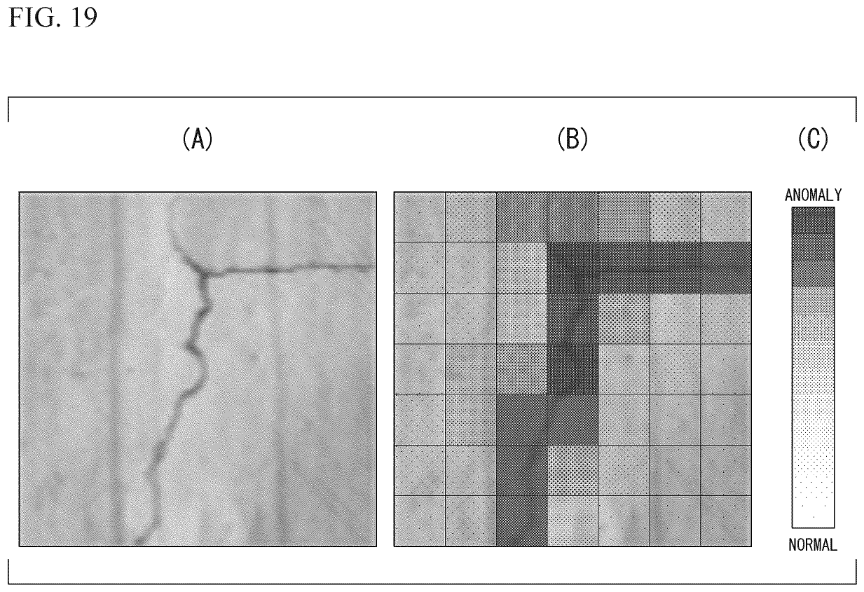

FIG. 19 is a diagram illustrating examples of inspection results from the anomaly display device according to an embodiment. An example of pictures displayed by the picture display portion D30 in the “inspection” process will be explained with reference to said diagram. The picture display portion D30 displays an input picture or an input picture P′ that is an inspection target, and displays anomaly detection results R in accordance with the input picture P.

FIG. 19(A) illustrates an example of an input picture P. FIG. 19(B) illustrates an example of anomaly detection results R in accordance with the input picture P. FIG. 19(C) illustrates an example of a legend corresponding to FIG. 19(B). In said diagram, locations estimated to be anomalous are indicated with dark colors, and locations estimated to be normal are indicated with light colors.

The input picture P illustrated in FIG. 19(A) has cracks, and the cracked portion is an anomaly. Therefore, in the anomaly detection results R illustrated in FIG. 19(B), the cracked portion is displayed with a dark color. The user can thus know that there anomalies at the locations of the dark portions.

Among the picture display boxes D31, for example, the input picture P may be displayed at reference number D311, and anomaly detection results R may be displayed at reference number D313. Reference number D312 may display nothing, or may display other information such as a company logo, an advertisement, or the operating method.

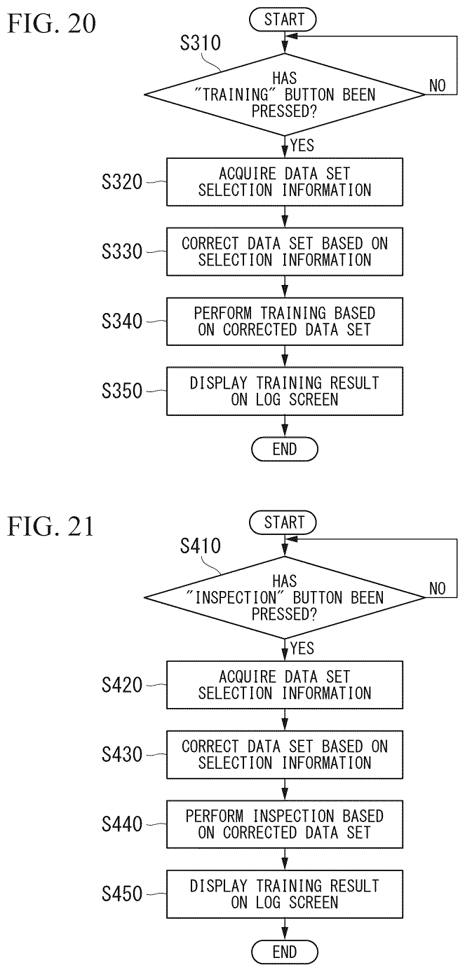

FIG. 20 is a flow chart for explaining a series of operations in a training process for an anomaly display device according to an embodiment. The series of operations for the “training” process in the anomaly display device 80 will be explained with reference to said diagram.
(Step S310) The starting information acquisition unit 810, upon detecting that the “training” button has been pressed, outputs the starting information IS to the inference unit 10 and advances the process to step S320. The “training” button being pressed may include situations in which the “training” button is not directly pressed, for example, situations in which the selection button D211 is selected and the execute button D23 is pressed. Additionally, the starting information acquisition unit 810 may output the starting information IS by being triggered by image capture being performed by the image capture unit.
(Step S320) The correction selection information acquisition unit 806 acquires data set selection information, i.e., correction selection information ISEL.
(Step S330) The inference unit 10 acquires, as input pictures P′, input pictures P that have been corrected based on the correction selection information ISEL.
(Step S340) The anomaly detection unit 30 is trained based on the corrected input pictures P′.
(Step S350) The display unit 840 displays the time required for training, the number of pictures processed, etc., as training results, on the log information display portion D40.

FIG. 21 is a flow chart for explaining a series of operations in an inspection process for an anomaly display device according to an embodiment. The series of operations for the “inspection” process in the anomaly display device 80 will be explained with reference to said diagram.
(Step S410) The starting information acquisition unit 810, upon detecting that the “inspection” button has been pressed, outputs the starting information IS to the inference unit 10 and advances the process to step S420. The “inspection” button being pressed may include situations in which the “inspection” button is not directly pressed, for example, situations in which the selection button D221 is selected and the execute button D23 is pressed.

Additionally, the starting information acquisition unit 810 may output the starting information IS by being triggered by image capture being performed by the image capture unit.
(Step S420) The correction selection information acquisition unit 806 acquires data set selection information, i.e., correction selection information ISEL.
(Step S430) The inference unit 10 acquires, as input pictures P′, input pictures P that have been corrected based on the correction selection information ISEL.
(Step S440) The anomaly detection unit 30 performs anomaly detection on the corrected input pictures P′.
(Step S450) The display unit 840 displays anomaly detection results R, the paths to locations at which the anomaly detection results R are stored, the time required for anomaly detection, the number of pictures processed, etc., as inspection results, on the log information display portion D40.

### [Modified Example of Mode Display Unit]

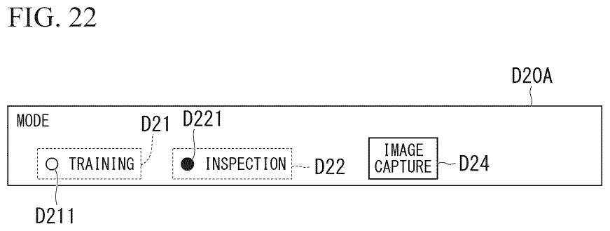

FIG. 22 is a diagram for explaining a first modified example of an anomaly display device according to an embodiment. A mode display portion D20A will be explained with reference to said diagram. The mode display portion D20A is a modified example of the mode display portion D20. In the explanation of the mode display portion D20A, regarding features similar to those in the mode display portion D20, explanations thereof may sometimes be omitted by appending the same reference numbers thereto.

The mode display portion D20A differs from the mode display portion D20 in that an image capture button D24 is provided instead of the execute button D23. When the image capture button D24 is pressed by a user operation, the image capture unit provided in the anomaly display system 8 performs image capture, and provides the captured pictures as the input pictures P.

The anomaly display system 8 may employ, for example, a configuration in which image capture is performed by a prescribed operation while an application is starting instead of a configuration in which an image capture button D24 is provided.

### [Modified Example of Picture Display Unit]

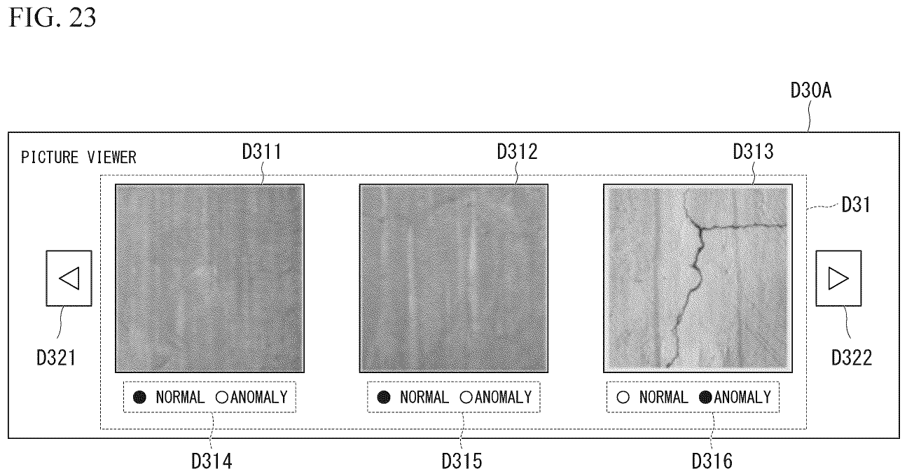

FIG. 23 is a diagram for explaining a second modified example of an anomaly display device according to an embodiment. A picture display portion D30A will be explained with reference to said diagram. The picture display portion D30A is a modified example of the picture display portion D30. In the explanation of the picture display portion D30A, regarding features similar to those in the picture display portion D30, explanations thereof may sometimes be omitted by appending the same reference numbers thereto.

The picture display portion D30A differs from the picture display portion D30 in that reference number D314 to reference number 316 are further provided as normal/anomaly selection buttons. The normal/anomaly selection buttons are used to select either normal or anomaly by a user operation. When performing “training”, the anomaly detection unit 30 is trained based on only pictures selected as being normal.

### [Summary of Anomaly Display System]

According to the embodiment explained above, the anomaly display system 8 acquires starting information IS, which is information for starting anomaly detection, by being provided with the starting information acquisition unit 810, acquires input pictures P by being provided with the input picture acquisition unit 805, executes anomaly detection based on the starting information IS by being provided with the anomaly detection unit 30, and displays information based on the detected results by being provided with the display unit 840. The anomaly display device 80 executes anomaly detection after acquiring the starting information IS, and does not need to communicate with external devices via a communication network until the results thereof are displayed.

Therefore, according to the present embodiment, the processing speed for the anomaly detection performed by the anomaly display device 80 does not depend on the network speed of a communication network or the processing speed of external devices, and anomaly detection can be performed at a high speed. Additionally, according to the present embodiment, the anomaly display device 80 does not transfer the input pictures P to an external device via a communication network. Therefore, situations in which confidential information is leaked can be avoided.

According to the present embodiment, the anomaly detection unit 30 is trained based on feature maps extracted by the inference unit 10. Multiple feature maps are extracted from a single input picture P. For example, in the example illustrated in FIG. 4, the inference unit 10 has nine layers, and 32+16+24+40+80+112+192+320+1280=2096 feature maps are extracted from a single input picture P. That is, since training is performed based on a large number of feature maps extracted from a single input picture P, training can be sufficiently performed even with a small number of input pictures P. The anomaly display device 80 can be sufficiently trained, for example, even if there are only about 40 input pictures P.

Therefore, according to the anomaly display device 80, training for anomaly detection can be performed even at sites in which collecting input pictures P is difficult.

Additionally, since there only needs to be a small number of input pictures P according to the present embodiment, the anomaly display device 80 can be trained at a high speed.

Additionally, according to the embodiment described above, the starting information IS includes paths indicating locations where input pictures P are stored, and the input picture acquisition unit 805 acquires the input pictures P stored at the locations indicated by the paths. Therefore, according to the present embodiment, a user can easily train the anomaly display device 80.

Additionally, according to the embodiment described above, the starting information IS includes an image capture starting signal for making the image capture unit capture images, and the input picture acquisition unit 805 acquires the input pictures P of which images were captured by the image capture unit. Therefore, according to the present embodiment, a user can train the anomaly display device 80 based on images captured on-site, even if input pictures P are not prepared in advance.

Additionally, according to the embodiment described above, a picture correction unit 807 for correcting the input pictures P is further provided, and the anomaly detection unit 30 executes anomaly detection based on the input pictures P′ corrected by the image correction unit 807. Therefore, according to the present embodiment, the anomaly display device 80 can perform “training” or “inspection” based on the corrected input pictures P′ even in cases in which the contrast in the input pictures P is not sharp, etc.

Additionally, according to the embodiment described above, correction selection information ISEL is acquired by providing a correction selection information acquisition unit 806. The image correction unit 807 executes the correction process based on the acquired correction selection information ISEL. The correction selection information ISEL is information selected by a user. In other words, the user can select the type of correction.

Thus, according to the present embodiment, even if the input pictures P are not sharp, the anomaly display device 80 can perform “training” or “inspection” based on the input pictures P′ corrected to make the pictures sharp.

Additionally, according to the embodiment described above, the anomaly detection unit 30 is pre-trained by prescribed normal pictures. Therefore, a user can easily use the anomaly display device 80.

Additionally, the anomaly display device 80 can accurately detect anomalies.

Additionally, according to the embodiment described above, the starting information IS includes training execution selection information indicating whether to perform “training” or “inspection”, and the anomaly detection unit 30 executes either “training” or “inspection” based on the training execution selection information included in the starting information IS.

Therefore, according to the anomaly display device 80, both “training” and “inspection” can be executed by using the display screen D1, which is a single GUI. Therefore, a user can easily use the anomaly display device 80.

Additionally, the anomaly detection unit 30 splits feature maps generated from input pictures and performs anomaly detection based on mean value vectors and variances corresponding to multiple split regions, which are regions into which the feature maps have been split. Furthermore, the display unit 840 can easily make a user discover the locations in the input pictures at which anomalies have occurred by displaying the input pictures in association with results calculated separately for said split regions. As a result thereof, a user can easily recognize anomalous locations included in the input pictures.

The screen configuration of the display screen D1 is not limited to the examples described above. For example, for the “training” process, the screen may include a selection portion for normal pictures that are to be training targets, a training parameter setting portion, and a display portion for threshold values for determining anomalies calculated from the training results. Furthermore, for the “inspection” process, the screen may include a threshold value setting portion for determining anomalies, an inspection result display setting portion, a display portion, etc. for determination results such as normal or anomaly, etc.

All or some of the functions of the units provided in the anomaly detection system 1 and the anomaly display system 8 in the above-mentioned embodiment may be realized by recording a program for realizing these functions on a computer-readable recording medium, and making a computer system read and execute the program recorded on this recording medium. The “computer system” mentioned here includes an OS and hardware such as peripheral devices.

Additionally, the “computer-readable recording medium” refers to portable media such as magneto-optic disks, ROMs, and CD-ROMs, and to storage units such as hard disks provided internally in computer systems. Furthermore, the “computer-readable recording medium” may include those that retain the program dynamically, for a short period of time, such as communication lines in the case in which the program is transmitted over a network such as the internet, or those that retain the program for a certain period of time, such as a volatile memory inside a computer system serving as a server or a client in such a case. Additionally, the above-mentioned program may be for realizing just some of the aforementioned functions, and furthermore, the aforementioned functions may be able to be realized in combination with a program already recorded in the computer system.

Although modes for carrying out the present invention have been explained by describing embodiments above, the present invention is not limited to such embodiments, and various modifications and substitutions may be made within a range not departing from the spirit of the present invention.

### REFERENCE SIGNS LIST

1 Picture detection system
10 Inference unit
30 Anomaly detection unit
50 Image capture device
60 Information processing device
310 Feature map acquisition unit
320 Compression unit
330 Splitting unit
340 Operation unit
350 Output unit
341 Calculation unit
342 Addition unit
360 Comparison unit
361 Threshold value information storage unit
P Input picture
R Anomaly detection result
90 Product inspection system according to conventional art
91 Product conveyance belt
93 Image capture unit
94 Gripping device
95 Picture processing server
98 Product
NW Network
8 Anomaly display system
81 Storage device
82 Input device
80 Anomaly display device
805 Input picture acquisition unit
806 Correction selection information acquisition unit
807 Picture correction unit
810 Starting information acquisition unit
820 Pre-trained backbone
830 Anomaly detection model
840 Display unit
831 Pre-process
832 CNN
833 Post-process
834 Training result head
P11 Training picture
P12 Inspection picture
R1 Inspection result heat map picture
R2 Inspection result score
IS Starting information
ISEL Correction selection information
D1 Display screen
D10 Data set display portion
D20 Mode display portion
D23 Execute button
5 D30 Picture display portion
D31 Picture display box
D40 Log information display portion

1. An anomaly display device comprising:
a starting information acquisition unit that acquires starting information including information for starting anomaly detection for detecting an anomaly in an image included in an input picture;
an input picture acquisition unit that acquires the input picture;
an anomaly detection unit that executes the anomaly detection, based on the acquired starting information, by comparing the acquired input picture with information based on a prestored normal picture; and
a display unit that displays, in overlay on the input picture, information based on information detected by the anomaly detection unit.

2. The anomaly display device according to claim 1, wherein:
the starting information includes a path indicating a location at which the input picture is stored; and
the input picture acquisition unit acquires the input picture stored at the location indicated by the path.

3. The anomaly display device according to claim 1, wherein:
the starting information includes an image capture starting signal for making an image capture unit capture the image; and
the input picture acquisition unit acquires the input picture obtained by the image being captured by the image capture unit.

4. The anomaly display device according to claim 1,
further comprising a picture correction unit that corrects the input picture;
wherein the anomaly detection unit executes the anomaly detection by comparing the input picture corrected by the picture correction unit with a prestored normal picture.

5. The anomaly display device according to claim 4, further comprising a correction selection information acquisition unit that acquires correction selection information for selecting a type of correction process to be executed by the picture correction unit.

6. The anomaly display device according to claim 1, wherein the anomaly detection unit is pretrained by a prescribed normal picture.

7. The anomaly display device according to claim 1, wherein:
the information based on a prestored normal picture includes information on a mean value vector and variance of the normal picture;
the anomaly detection unit performs anomaly detection corresponding to multiple split regions, which are regions into which the input picture has been split; and
the display unit displays, in overlay on the input picture, the information detected by the anomaly detection unit, so as to be associated with the multiple split regions.

8. The anomaly display device according to claim 1, wherein:
the starting information includes training execution selection information indicating whether the anomaly detection unit is to perform training based on a prescribed normal picture or is to execute the anomaly detection; and
the anomaly detection unit executes either the training or the anomaly detection based on the training execution selection information included in the starting information.

9. An anomaly display program for making a computer execute:
a starting information acquisition unit step of acquiring starting information including information for starting anomaly detection for detecting an anomaly in an image included in an input picture;
an input picture acquisition step of acquiring the input picture;
an anomaly detection step of executing the anomaly detection, based on the acquired starting information, by comparing the acquired input picture with a prestored normal picture; and
a display step of displaying, in overlay on the input picture, information based on information detected by the anomaly detection step.

10. An anomaly display system comprising:
an image capture unit that captures the image; and
the anomaly display device according to claim 3, which executes the anomaly detection on the input picture captured by the image capture unit, and which displays information obtained as a result of the execution.

11. An anomaly display method including:
a starting information acquisition step of acquiring starting information including information for starting anomaly detection for detecting an anomaly in an image included in an input picture;
an input picture acquisition step of acquiring the input picture;
an anomaly detection step of executing the anomaly detection, based on the acquired starting information, by comparing the acquired input picture with a prestored normal picture; and
a display step of displaying, in overlay on the input picture, information based on information detected by the anomaly detection step.
